(19) United States
(12) Patent Application Publication
(10) Pub. No.: US 2024/0328923 A1
(43) Pub. Date: Oct. 3, 2024

(54) Conductive deposit test apparatus and method

(71) Applicant: Tannas Company, Midland, MI (US)

(72) Inventors: John V. Bucci, Midland, MI (US); Gregory C. Miller, Midland, MI (US); Douglas J. Wirsing, Midland, MI (US); Sarah R. Nuss-Warren, Midland, MI (US); Jessica L. Hoye, Burtonsville, MD (US); Rico Pelz, Landau (DE); Gunther Mueller, Landau (DE); William Van Bergen, Coleman, MI (US); Egon Bruggeman, Dronten (NL)

(73) Assignee: Tannas Company, Midland, MI (US)

(21) Appl. No.: 18/445,886

(22) Filed: Feb. 29, 2024

Related U.S. Application Data
(63) Continuation-in-part of application No. PCT/US2022/000017, filed on Aug. 30, 2022.
(60) Provisional application No. 63/360,052, filed on Aug. 31, 2021.

(51) Int. Cl. G01N 17/02; G01N 17/04; G01N 27/07

(52) U.S. Cl. CPC G01N 17/02; G01N 17/04; G01N 27/07

(57) ABSTRACT

Conductive deposit test apparatus for testing a fluid includes conductive substrate deposit unit having a conductive substrate mount, and mounted on said mount, conductive substrate(s) narrowly spaced apart in a pattern of a plurality of adjacent members forming a conductive deposit test fluid deposit receiver; a test cell, which includes a test cell housing together with said conductive substrate(s) mounted on said mount, and which is configured to hold the test fluid; and a source of electric power for heating the apparatus, passing electricity through said conductive substrate(s), and so forth. A non-electrically conductive covering element may constrain movement of the fluid in a narrow gap in proximity to the conductive substrate. Data monitoring and/or analyzing component(s) and/or equipment can be provided. Method for testing a test fluid includes steps of providing the test apparatus; providing power, and operating the apparatus under elevated temperature; and monitoring/analyzing generated data.

This claims the benefits under 35 USC 119, 120, 363 and/or 365 and so forth, as a continuation-in-part of international application No. PCT/US2022/000017 filed on Aug. 30, 2022 A.D., published as WO 2023/033860 A1 and A4, which, as does the present matter, claims the benefits of provisional application No. US 63/360,052 filed on Aug. 31, 2021 A.D. The specifications of those applications to include drawings are incorporated herein by reference in their entireties.

### FIELD OF THE INVENTION

Of concern are conductive deposit test apparatus and methods. These may be employed to determine tendencies of fluids to form electrically or electronically conductive deposits on metallic or other material substrates, for example, of or with copper. Of particular concern are the potential for fluids to corrode metal, such metallic components, and the tendency of their resultant corrosion products to form conductive deposits that can interfere with transmission of electrical power or control signals due to leakage currents, short circuiting, and so forth and the like.

### BACKGROUND TO THE INVENTION

In today's world, many mechanical components of machinery or equipment, which include motor vehicles, engines, motors, generators, and so forth, have built-in electrical or electronic devices for monitoring and/or control thereof. These components often contain fluids for lubricating, transmitting mechanical power and/or cooling. Problems can arise, however, from proximity to, if not contact with, the electrical/electronic circuits and the fluids, particularly as the fluids, which often include complex chemical additive packages, degrade and produce chemical entities that corrode the electrical components such as wires and tracings, and metallic surfaces of bushings, washers, bearings, and areas with small gaps, to hinder or even halt performance of such components or form conductive material deposits.

Although such problems can occur in a number of systems, electric vehicles represent a special area in which such problems appear, which, of course, can affect performance. The electric vehicles of today contain electronics that are subject to both fluid immersion and fluid vapors that potentially cause problems over time. Bridging deposits that allow electricity to pass or leak across sections of electronics may be an issue with some electric vehicles, to the point that they can lead to catastrophic failure. Dendrite formation also has the potential to cause failure in electrical components, which presents a serious problem.

Patent No. U.S. Pat. No. 8,149,004 B2 (Apr. 3, 2012) to Raju et al. discloses a corrosion sensor for monitoring and controlling lubricant acidity. In general, it has an element corrodible in a lubricant or hydraulic oil, wherein the corrosion sensor is adapted to monitor degradation of the lubricant or hydraulic oil. This patent to Raju et al. is incorporated herein by reference.

Patent No. U.S. Pat. No. 9,488,612 B2 (Nov. 8, 2016) to Watts discloses a lubricant test method. In general, it determines compatibility of lubricating fluid with an energized electrical or electronic component by contacting a test apparatus with the fluid; applying an electrical current to the test apparatus; and monitoring the current flow through the test apparatus over time. The test apparatus includes at least one pair of conductors separated by an insulator that does not extend across the whole of the opposing surfaces of the conductors. The electrical current is applied across the pair of conductors. This patent to Watts is incorporated herein by reference.

Beyer et al., Tribology Online, Vol. 14, No. 5, 2019, pp. 428-437, reports on lubricant concepts for electrified vehicle transmissions and axles. It states that many future electrified vehicle transmissions may have lubricant in direct contact with powered motor windings such as of copper, which may corrode as well as challenge the lubricant's heat transfer capability and thermal stability. Electrical and heat transfer properties of lubricants are discussed, as is copper corrosion.

Gahagan et al., Intl. J. Automotive Eng., Vol. 7, 2016, pp.115-120, reports on new insights on the impact of automatic transmission fluid (ATF) additives on corrosion of copper. It states that electrical resistance of copper wires is measured, with corrosion generated providing insight to formulate oils to better protect copper and copper alloys.

Hunt et al., SAE Technical Paper 2020-01-0561, Apr. 14, 2020, reports on understanding vapor and solution phase corrosion of lubricants used in electrified transmissions. It states that, unlike commonly used copper strip tests (versions of ASTM D130) that require high temperatures and long times to differentiate the corrosivity of fluids, the wire resistance test is sufficiently sensitive to allow real time assessment for efficiently screening lubricant chemistries over a range of potential operating temperatures. They found that in solution corrosion did not occur below 110° C., but, above 120° C., each lubricant showed its own temperature dependence although each became more corrosive with increase in temperature. Vapor phase corrosion, which occurred as low as 100° C., was also discussed. An oil may pass ASTM D130 corrosion specifications yet not protect against severe failure.

IPC No. 2.6.3.7, March 2007, is a surface insulation resistance (SIR) test method for quantifying the deleterious effects of fabrication, process or handling residues on SIR in the presence of moisture. Electrodes are long parallel traces (printed interdigitated comb patterns) on a standardized printed board or assembly. Samples are conditioned with measurements taken at high humidity. Electrodes are electrically biased during conditioning to facilitate electrochemical reactions.

The international searching authority of the aforementioned international application cited the following art:

Nelson et al., Pub. No. US 2011/0107815 A1. This discloses a method and system for diagnostics of a particulate matter sensor. In general, it purports to diagnose an operating condition of a conductive particulate matter sensor, which has a substrate having thereon two electrodes adapted to collect particulate matter between the electrodes that establishes an electrically conductive path through collected particulate matter between the electrodes, which can be detected by measuring electrical resistance between the electrodes. The diagnosis is performed by detecting whether water vapor condensate may be present between the electrodes, and, if it is, then measuring resistance between the electrodes while subjecting the sensor to conditions sufficient to evaporate any water vapor condensate and diagnosing a validation that the sensor is in proper operating condition if resistance increases in a manner consistent with evaporation of condensate.

Zantyl et al., Pub. No. US 2010/0081189 A1. This discloses a sample chamber. In general, it is for testing samples, and comprises a bottom plate connected to a cover plate, a sample reservoir for receiving a liquid and/or a sample to be tested, and a contact electrode, which is arranged entirely in the bottom plate, in the cover plate, or between the bottom and cover plates, and which is electrically conductively connected to a conductor element or semiconductor element disposed in and/or on the sample chamber, wherein the bottom and/or cover plate(s) is (are) designed in such a way that an electrical contact with the contact electrode can be established from the outside in such a way that an electrically conductive connection to the conductor element or to the semiconductor element can be established from the outside through the bottom plate or through the cover plate via the contact electrode.

Van Popta et al., Pub. No. US 2010/0307238 A1. This discloses a humidity sensor and method of manufacturing the same. In general, the humidity sensor comprises an insulating substrate, a moisture-sensitive layer, and at least a detection electrode contacting the moisture-sensitive layer, wherein the moisture-sensitive layer is a porous, photocatalytic metal oxide.

Kauffman et al., Pub. No. US 2004/0060344 A1. This discloses a sensor device for monitoring the condition of a fluid and a method of using the same. In general, it purports to be a compact apparatus and method providing an efficient manner for monitoring the condition and level of a functional fluid directly in operating equipment, in which a sensor device is provided that includes a plurality of liquid sensors and a plurality of vapor sensors that, when used in conjunction with one another at different temperatures, can provide a thorough evaluation of the oxidative degradation, liquid contamination, and solid contamination of the fluid to detect the end of the useful life of the fluid; and that, by providing liquid sensors and vapor sensors on the same device, it allows for a compact, efficient, and economically feasible manner to monitor the condition of fluid as well as detecting abnormal operating conditions prior to further component damage and eventual equipment failure.

Peplow et al. (The Lubrizol Corporation), Pub. No. WO 2021/247428 A1. This discloses a surface isolation resistance compatibility test system and method, which, in general, includes a system for detecting deposit formation on electrically-conductive materials in vapor and liquid phases that includes a test cell for receiving a test liquid, for example, a lubricant. A heater heats the test liquid to generate a vapor phase of the test liquid in the test cell. A support frame supports at least a first set of electrical conductors in the test liquid and at least a second set of electrical conductors in the vapor phase, each of the first and second sets of conductors including a live electrical conductor and a neutral electrical conductor. A power source supplies an electric current to each of the live electrical conductors. A sensor component detects an electrical property of each of the sets of conductors, the electrical property changing in response to formation of an electrically-conductive deposit that connects the first and second conductors in a respective set of conductors. Preferably, the electrical properties are detected by magnetic sensors such as Hall effect sensors or eddy current sensors. Tannas Company owns Peplow et al.

### SOME DESIDERATA

It would be desirable to ameliorate, if not solve, one or more problems in the art, and to improve the art. More particularly, it would be desirable to more accurately assess reactions of lubricating and/or heat transfer fluids with electrical system components, especially those of or containing copper, in electrified environments, for example, in electric vehicles, where these components are in direct contact with these fluids or volatized vapors thereof. It would be desirable to provide a method that combines both corrosion and deposit formation aspects. It would be desirable also to be able to simulate appropriate conditions at a small, bench scale to efficiently evaluate the corrosion potential and conductive deposit formation tendency of fluids in contact with electrical components that are subjected to an applied voltage. It would be desirable to provide apparatus for carrying out such assessments and methods. It would be desirable to provide the art an alternative.

### A SUMMARY OF THE INVENTION

Provided hereby is a conductive deposit test apparatus for testing a test fluid in the presence of an electrical conductor through which an electric current can pass, which comprises a conductive substrate deposit unit having a conductive substrate mount, and mounted on said mount, a conductive substrate narrowly spaced apart in a pattern of a plurality of adjacent members that forms a conductive deposit test fluid deposit receiver; a test cell, which includes a test cell housing together with said conductive substrate(s) mounted on said mount, said test cell configured to hold the test fluid during testing; a source of electric power capable of passing through said conductive substrate(s); and, optionally, a source for heating and/or cooling the test fluid held in the test cell housing during testing. Restriction or constraint of sample fluid movement in proximity to the conductive substrate(s) can be provided, say, through a covering member, for example, a covering board, to provide a narrow gap. Data monitoring and/or analyzing component(s) and/or equipment can be provided. Also provided is a method for testing a test fluid, which comprises steps of providing the conductive deposit test fluid apparatus, and power and optionally heat to said apparatus; operating said test apparatus; and monitoring/analyzing data generated therefrom.

The invention is useful in testing organic fluids and electrical conductors.

Notably, one or more problem(s) in the art is (are) ameliorated if not solved hereby, and the art is provided one or more alternative(s) and is advanced in kind. The invention has significant advantages and benefits over methods aimed solely at characterizing corrosion tendencies of fluids in contact with copper components. It distinguishes over the prior art in that it provides a direct measurement of the formation of conductive deposits when powered electrical components such as copper conductors are exposed to lubricating or thermal fluids and their volatized vapors at elevated temperatures, and so it performs better than the prior art because it not only characterizes corrosion potential but also characterizes the tendency of these corrosion products and other formulation constituents to form deposits that can conduct electricity along unintended pathways. In testing the organic fluids and electrical conductors, it finds utility in areas where both may co-exist in proximity or with large spacing, and may include the fluid in a vapor state exposed to materials thereof. In addition, the invention simulates locations where bulk fluid flow is constrained and these deposits are most likely to form. This is of particular importance to applications like motor windings and interconnects where parallel conductors are in close proximity to each other in areas of low fluid flow. It can have particular applicability, for example, in electric vehicles.

Numerous further advantages attend the invention.

### DRAWINGS IN BRIEF

The drawings form part of the specification hereof. With respect to the drawings, which are not necessarily drawn to scale, the following is briefly noted:

FIG. 1 is a plan view of an embodiment of a test board for a conductive deposit test apparatus hereof (front/obverse side).

FIG. 2 is a plan view of an embodiment of a test board for a conductive deposit test apparatus hereof (back/reverse side).

FIG. 3 is a sectional, perspective view of an embodiment of a test cell housing (cut away part) assembly holding a single board component with its support for a conductive deposit test apparatus hereof.

FIG. 4 is a perspective view of an embodiment of a support and cover holding a double board component for a conductive deposit test apparatus hereof.

FIG. 5 is a perspective, sectional view of an embodiment such as of FIG. 4.

FIG. 6 depicts detail seen within the circle 6 in FIG. 5.

FIG. 7 is a perspective view of a three-board conductive substrate deposit unit for a conductive deposit test apparatus hereof.

FIG. 8 is a perspective, sectional view of a test cell having a three board conductive deposit substrate unit as of FIG. 7 therein.

FIG. 9 is a top, perspective view of a multi test cell carousel equipped with plurality of test cells, here, ten, for a conductive deposit test apparatus hereof.

FIG. 10 is another perspective view of a multi test cell carousel such as in FIG. 9, which resides in a heating bath, say, of liquid, or, sand and/or so forth and the like, for a test setup of a conductive test apparatus hereof. A card edge connected cable is shown for illustration.

FIG. 11 is a graph of liquid phase resistance vs. test time of representative passing and failing fluids.

FIG. 12 is a graph of vapor phase resistance vs. test time of representative passing and failing fluids.

FIG. 13 is a graph of the conductive loop resistance vs. test time of representative passing and failing fluids.

FIG. 14 is an example test result that includes the standard deviation-based metric and limits for use in aiding in determination of pass/fail criteria.

FIG. 15 is a test measurement circuit diagram for a conductive deposit test apparatus hereof.

FIG. 16 is schematic plan for a data collection and processing system for a conductive deposit test apparatus hereof.

FIG. 17 is a schematic plan for a centralized concept conductive deposit test apparatus hereof.

FIG. 18 is a schematic plan for a daisy chain connected distributive concept conductive deposit test apparatus hereof.

FIG. 19 is a schematic plan for individually connected distributive concept conductive deposit test apparatus hereof.

FIG. 20 is an exploded view of components making up a conductive substrate deposit unit for a test cell for a conductive deposit test apparatus hereof.

FIG. 21 is an elevational view of the obverse of the conductive deposit test fluid deposit receiver (conductive substrate mount plus conductive substrate) of the unit found in

FIG. 20. The rule is depicted in inches, with one inch equaling 2.54 centimeters (cm).

FIG. 22 is an elevational view of the reverse of the conductive deposit test fluid deposit receiver of the unit of FIG. 20. Rule is in inches, with one inch equaling 2.54 cm.

FIG. 23 is a bottom perspective view of the support member for the conductive deposit test fluid receiver of the unit of FIG. 20.

FIG. 24 is a top view of the support member of FIG. 20.

FIG. 25 is an elevational view of the conductive substrate deposit unit of FIG. 20, assembled, with the test portions of the obverse of the conductive deposit test fluid deposit receiver covered by an outer board spaced apart from the deposit receiver by standoffs, for example, about 0.005 of an inch (about 127 microns) tall, to form a narrow gap for test fluid.

FIG. 26 is an elevational view of the reverse of the assembled conductive substrate deposit unit of FIG. 25.

FIG. 27 is an elevational view of the reverse of the conductive deposit test fluid deposit test board of FIG. 27, with resistance temperature detectors (RTDs) or thermocouples (TCs) installed thereon. RTDs are advantageously employed.

FIGS. 28-30 comprise graphs of conductive deposit testing (CDT) analysis-data processing algorithms that may be employed in the practice of the present invention, to include as may be found with the present conductive deposit test apparatus, with FIG. 28 showing a standard resistance pattern; with FIG. 29 showing a conditioning algorithm; and with FIG. 30 showing a variability assisted process. Therein, the conditioning algorithm does not change passing runs, and it eliminates transient spikes in resisistance and allows for better identification of failing condition; and analysis by variability assessment indicates a point at which resistances begin to fluctuate owing to stochastic deposit-forming reactions. Both forms of data processing give similar results for failing time, but the variability-assessed process provides a simple number, say, an integer from zero to five, for analysis with respect to the failure rate.

FIGS. 31 et seq. depict some further embodiments, as follows:

FIG. 31 is a bottom perspective of an individual being a stand-alone concept, combined test cell heater with data collection head construction including a measurement multiplexer (MUX) board, with its top section including the MUX board, and the bottom section being a test cell container with the test cell temperature regulator, for example, a dry block heater. This embodiment has separate RTDs for temperature measurement and/or control. Compare with the RTDs mounted on the test board in FIG. 28 and pertinent predecessor figures.

FIG. 32 is a bottom perspective plan view of the construction of FIG. 31.

FIG. 33 is a top perspective plan view of the construction of FIG. 31, focusing upon the test cell container with test cell dry heater block.

FIG. 34 is a top, inside perspective view of an adapter employed in the test cell container with test cell dry heater block of FIG. 33.

FIG. 35 is an exploded view of some of the components making up the construction of FIG. 31, noting, for example, the additional detail provided within FIGS. 32-34.

FIG. 36 is a top perspective view in partial section of a liquid bath construction test device, which employs multiple test cells, each having MUX board capability.

FIG. 37 is a top perspective view of a liquid bath device having stand alone test cells.

FIG. 38 is a front perspective view of a multi-module stand alone test device unit hereof.

FIG. 39 is a rear perspective view of a unit such as in FIG. 38.

FIG. 40 is a graph of typical test results for fluid testing with open test board in which there is not a covering board in close registery to the test board during testing of the fluid versus fluid testing with covering board that would provide a narrow gap in which test fluid resides during testing. Significantly superior, unexpected results are obtained with the covered test board, which also is electronically inert.

FIG. 41 is a rear plan view of a conductive substrate deposit test apparatus as a stand-alone concept, combined test cell heater with data collection head construction, in which dry block heating is employed, and its docking station having the capability of providing power and an internet connection for each stand-alone unit for and during operation.

FIG. 42 is a graph of results from a test run of an oil in a conductive deposit test apparatus of the invention, to include a showing that its continuity loop trace remained intact.

FIG. 43 is a graph of results from a test run of another oil in a conductive deposit test apparatus of the invention, including a showing of its continuity loop trace being depleted.

FIG. 44 is an amalgamation of two graphs, the first, upper graph a plot of liquid and vapor results from a test run of an oil in a conductive deposit test apparatus of the invention (Sample Output for Conductive Deposit Test), and the second, lower graph a plot of data from the first graph in base-10 logarithmic form (Sample Conductive Deposit Factor Output) so as to determine a Conductive Deposit Factor value for a data report.

FIG. 45 illustrates a summary of equations employed in determining a failure point of Conductive Deposit Test results hereof through graphical representations, which include moving average, derivative, cumulative average difference, and normalized sum equations.

### ILLUSTRATIVE DETAIL

The invention can be further understood by the detail set forth below. As with the foregoing, the following, which may be read in light of the drawings, should be read in an illustrative but not necessarily limiting sense:

In general, the present conductive deposit test apparatus is used to evaluate the tendency of a test fluid for conductive deposits that may be obtained by applying voltage to a series of electrical conductors in the presence of the test fluid. The apparatus includes a conductive substrate mount; conductive substrate(s) mounted on the mount; a test cell, which includes a test cell housing together with said conductive substrate(s) mounted on said mount; a source of electric power capable of passing through the conductive substrate(s); and, optionally, a source of heat to heat the test fluid held in the test cell during testing. Beneficially, means for restricting fluid movement in proximity to the conductive substrate(s) can be provided. Data monitoring and/or analyzing component(s) and/or equipment can be provided. The present test apparatus and method(s) are developed for determining the tendency of fluid(s) to form conductive deposit(s) on conductive substrate(s).

The test fluid may include any liquid that can be held by the test cell of the present apparatus. Beneficially, however, the test fluid is a liquid that is evaluated or is a liquid from which a vapor is generated that may also be evaluated as well as the liquid or by itself. As target test fluids, those that form conductive deposits with the conductive substrate(s) or those that are suspected of being capable of or simply being tested for forming deposits with the conductive substrate(s) may be beneficially employed. Examples of test fluids that may be employed in the practice of the present invention are or include automatic transmission fluids (ATFs), especially for electric vehicle powertrains. Nonetheless, other fluids and applications having conductors in electrified environments exposed to the fluids such as lubricants, heat-transfer fluids, transformer oils, and so forth and the like, may be employed as the test fluid. Strictly speaking, a fluid itself may be conductive, but the same may be detected by other tests generally known elsewhere, with a conductive fluid itself rendering a “failure” result in the practice of the present invention. However that may be, test fluid employed in the practice of the invention has been measured at the end of testing, without an observable drop in resistance attributable to a change in fluid conductivity. Although it is not clear whether it is universally true, visual evidence of deposits in failed test samples suggests that loss of resistance is indeed due to conductive deposit formation. The present invention also includes characterization of a tendency of test fluid(s) to form conductive deposit(s) on conductive substrate(s) in accompanying vapor space where volatile components are released, for example, vapor escaping from a liquid phase exposed to electrical conductors such as in the case of the head space surrounding partially submerged components. As alluded to above, the present invention also encompasses characterization of areas where both liquid and vapor phases co-exist such as found with thin liquid films in the transition area between liquid and head space, areas where vapors may condense onto metal substrates, and so forth and the like.

The conductive substrate mount may be made of any suitable material. In general, it is an electric insulator. Examples of materials that may be used to make the conductive substrate mount include epoxy, Teflon polytetrafluoroethylene, phenolic and/or polyimide plastics, which may or may not be reinforced, say, with reinforcing particles and/or fibers. Preferred reinforcing materials include glass-fiber-reinforced materials such as, for example, G-10 or FR-4 materials, known in the art. The conductive substrate mount may take any suitable shape or size, say, polygonal, curvilinear or curved. The conductive substrate mount can be configured as a flat rectangle or modified rectangle, say, a test or covering board about 3-4 inches (about 7.62-10.16 cm) long by about 1-2 inches (about 2.54-5.08 cm) wide by about 0.05-0.07 of an inch (about 0.127-0.178 cm) thick.

The conductive substrate(s) mounted on the mount may be any suitable electrical conductor. In general, it (they) may corrode and have deposits formed on it (them) from the testing. The conductive substrate(s) notably is (are) copper or alloys thereof, most notably copper, although this can be extended to other metals and their alloys, for example, nickel, tin, silver, aluminum and so forth and the like, as well as polymeric conductor(s) and so forth and the like. The conductive substrate(s) is (are) mounted or formed on the conductive substrate mount in any suitable pattern that provides for being narrowly spaced apart in a pattern of a plurality of adjacent members, which may include comb teeth (combs) or fingers especially as they interlace, a series of oscillating forms in registry, an involute curved shape such as a spiral, an involute linear pattern such as a series of decreasing rectangles, squares, or triangles akin to a maze pathway, a series of concentric circles, ellipses, ovals, or squares, rectangles, or triangles, and so forth and the like. The conductive substrate(s) may be of any suitable dimension, for example, as the interlacing comb teeth or fingers that are composed of thin traces, for instance, independently at each occurrence, of an about 200-micron (about 2-millimeter (mm)), about 300-micron (about 3-mm) or about 350-micron (about 3.5-mm) distance, which may be taken as a lower limit, and an about 450-micron (about 4.5-mm), about 500-micron (about 5-mm) or about 600-micron (about 6-mm) distance, which may be taken as an upper limit, for example, an about 400-micron (about 0.4-mm) distance, for a width. The narrow spacings between the adjacent members of the conductive substrate(s) can be any suitable distance, say, independently at each occurrence, of an about 150-micron (about 1.5-mm), about 200-micron (about 2-mm) or about 250-micron (about 2.5 mm) distance, which may be taken as a lower limit, and an about 350-micron (about 3.5-mm), about 400-micron (about 4-mm) or about 500-micron (5-mm) distance, which may be taken as an upper limit, as for example, being an about 300-micron (about 0.3-mm) distance apart from one another. When the conductive substrate(s) is (are) mounted on the conductive substrate mount, a conductive substrate deposit unit with a conductive deposit test fluid deposit receiver is formed. The conductive substrate deposit unit typically contains other features such as electrical connections and leads, weep holes, mounting features, and so forth. The unit may be supported by a support member that secures it and interacts with the test cell housing to stabilize the unit in relation to the test cell housing. For example, a test board along with a covering outer board may slide into opposing grooves in a support member, pass through a hole in an upper, vapor-blocking or vapor-escape-hindering portion of the support member, and plug into a multi-pin electrical connector such as an S67537 SULLINS EBM06DREH 12-pin connector for connection to electrical/electronic monitoring/analyzing parts.

The conductive substrate deposit unit and the test cell housing, when assembled, form a test cell. The test cell is configured to hold the test fluid during testing. The test cell housing may be made with any suitable material that is inert with respect to the test fluid, can withstand elevated temperatures during testing, say, up to about 180° C. or about 200° C. or higher during testing and up to about 500° C. for post-test cleaning. Thus, the test cell housing may be made with various grades of stainless steel, other metal(s) such as titanium, chromium, vanadium, gold and/or glass or ceramic, such as 0.08-inch (0.2-cm)/14-gauge #316 stainless steel. The size of the test cell, as determined by internal dimensions of its housing, may vary, for a 14-gauge #316 stainless steel test cell housing being about from 3-4 inches (about from 7.62-10.16 cm) tall (height), by about from 1.5-2.0 inches (about from 3.81-5.08 cm) wide (width), by about from 0.6 to 1.0 inch (about from 1.52-2.54 cm) perpendicular to the height and width (across). Nonetheless, dimensions of the test cell housing are driven by the size and shape of the conductive deposit test fluid deposit receiver, circuit board size, with an exemplary test cell housing being about 1.91 inches (about 4.85 cm) wide by about 3.25 inches (about 8.26 cm) tall by about ¾ of an inch (about 1.905 cm) across. A test cell may hold about 14-18 mL of liquid test fluid, with test sample fill about 15-17 mL depending on the setup, for example, a 2-board or a 3-board stack. This is reflective of a test cell filled approximately to a halfway point, as for example, covering liquid-testing interlacing fingers, which is about 50% of the test cell volume.

A source of electrical power is provided. It can power various component(s) of the apparatus such as transformer(s); computing equipment, whether internal or external; monitor(s); heating and/or cooling equipment; a DC power supply, and so forth and the like. Line power may be used for heating, say, a bath, and running a computer/data logging system. The apparatus has a suitable power supply, for example, 5V DC, to apply to the conductive deposit test fluid deposit receiver (test board) or to the test board(s) and temperature measurement circuit(s) through employment of RTD or other temperature measurement devices, which may be on the reverse side of a test board with the conductive substrate(s) mounted on the obverse.

Corrosion and deposit behavior is believed to be influenced by the application of voltage to the test board(s). For example, voltage may be constantly applied or applied intermittently for measurement, with the latter capable of resulting in lesser amounts of deposits than the former.

A source for heating or cooling to heat and/or cool the test fluid held in the test cell housing may be provided. For instance, a liquid bath in which the test cell(s) holding test fluid(s) can be inserted, and by which temperature is controlled with accuracy and precision, may comprise the source for heating and/or cooling. Although any temperature may be employed depending on the fluid under consideration and other factors, operating temperatures during testing beneficially include elevated temperatures, especially those at least about 50° C. For ATF testing, the temperature of testing desirably is, independently at each occurrence, about from 60° C., 80° C. or 100° C. to about from 165° C. or 180° C., say, about from 80° C. to 165° C., for example, 150° C. or an advantageous range about from 80° C. to 150° C. Temperature can be controlled at a fixed setpoint for the duration of the test, could follow a predetermined ramping profile, or be periodically cycled throughout the test.

Some features of the invention are listed as follows:

| Feature | Comment |
|---|---|
| 10 | Conductive substrate deposit unit |
| 11 | Conductive substrate mount, e.g., board/card |
| 12 | Patterned conductive substrate, e.g, with interlacing fingers, |
| | e.g., on obverse (front) |
| 12S | Spacing between conductive substrate adjacent members |
| 12T | Continuity loop trace/conductive loop, e.g., on front near |
| | perimeter of the board 11, to monitor loss of the patterned |
| | conductive substrate 12, beneficially of the same material, |
| | thickness and width as the patterned conductive substrate 12 |
| | and also present for liquid and vapor contact |
| 13 | Temperature measurement circuit, e.g., on reverse |
| 13T | Temperature sensing member, e.g., RTD(s) on test board, or |
| | TC(s) |
| 14 | Covering board, which beneficially is non-electrically |
| | conductive or electrically inert |
| 15 | Gap-providing standoffs |
| 16 | Conductive substrate mount support member (board holder) |
| 16G | Groove to receive conductive substrate mount/covering board |
| 16H | Hole in upper vapor-blocking portion of support member |
| 17 | Electrical/electronic connector, e.g., multi-pin connector |
| 18 | Additional connectors and cabling to connect signal wires from |
| | test cells to data collection system |
| 19 | Computing system, e.g., external laptop or computing device, |
| | or device embedded in the data collection system |
| 20 | Test cell (conductive substrate deposit unit in test cell housing) |
| 21 | Test cell housing |
| 22 | Carousel for test cells |
| 23 | Heater for testing fluid sample(s) at elevated temperature |
| 24 | Wire connections for fingers to immerse in liquid, say, oil; |
| | fingers for contact by vapor from liquid; continuous loop; liquid |
| | and vapor RTDs. |

### Exemplary Embodiments

The following exemplary embodiments further illustrate the invention:

The metal of most interest for the conductive substrate(s) in preferred embodiments is copper owing to its wide use in circuitry, motor windings, and electrical systems. Although it is referenced below, other conductors such as nickel, tin, gold, silver, aluminum, and their alloys, and so forth, may be employed depending on the application and materials used.

### Apparatus

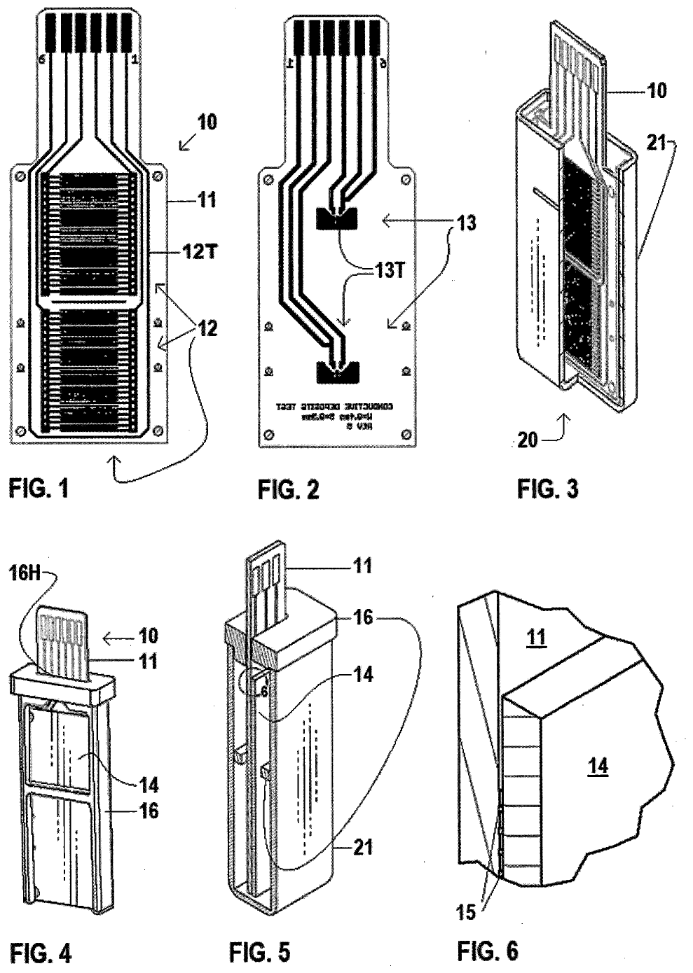

A preferred form of the test platform upon which the conductive deposit receiver sections are mounted is a printed circuit board with well-defined and repeatable conductive substrate trace patterns, for example, of copper or a suitable alloy thereof. This form has the advantage of providing tightly controlled spacing and exposed surface area of the conductive deposit receiving substrate such as copper or a suitable alloy thereof that can be accurately reproduced on many separate boards, each of which, in general, is employed only once in testing. The circuit board is made of a non-conductive substrate made, for example, of FR-4 glass fiber reinforced epoxy laminate, on which is mounted the copper/alloy as the conductive substrate in the interlacing finger patterns defined as the test board as depicted in FIGS. 1 and 2 and so forth. There are three chief operating elements to this circuit board:
Two separate, identically patterned sections, each made of copper/alloy deposited on the FR-4 mount by standard electroplating techniques followed by masking/etching to achieve the desired interlacing finger pattern with external connection points. These are used for sensing any change in resistance resulting from solid deposits joining otherwise separated conductors, typically between adjacent fingers. The bottom section is for immersion of the test fluid, typically as a liquid. The other section is above the bottom section and is for interaction with volatile components of the liquid sample in the space above the liquid phase.
One additional conductive trace made of copper/alloy for measuring resistance change related to corrosion. This trace encircles the test board, traversing both the liquid and vapor sections, but alternatively could be separated to measure each of these sections independently. This trace has the same nominal dimensions (weight, thickness) of the previously described finger traces. The resistance of this circuit is monitored to detect changes in the cross-sectional area of this trace owing to material loss from corrosion. This feature allows correlation of conductive deposit formation to corrosion behavior via independent measurements.

A constant DC voltage supply is provided, for example, nominally 5V. This is for application to the patterned sections and the conductive trace during testing as well as temperature measurement circuits.

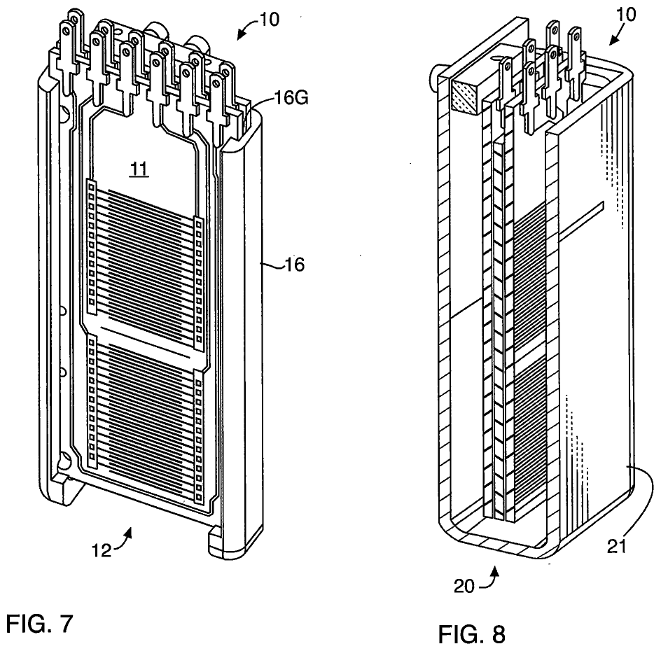

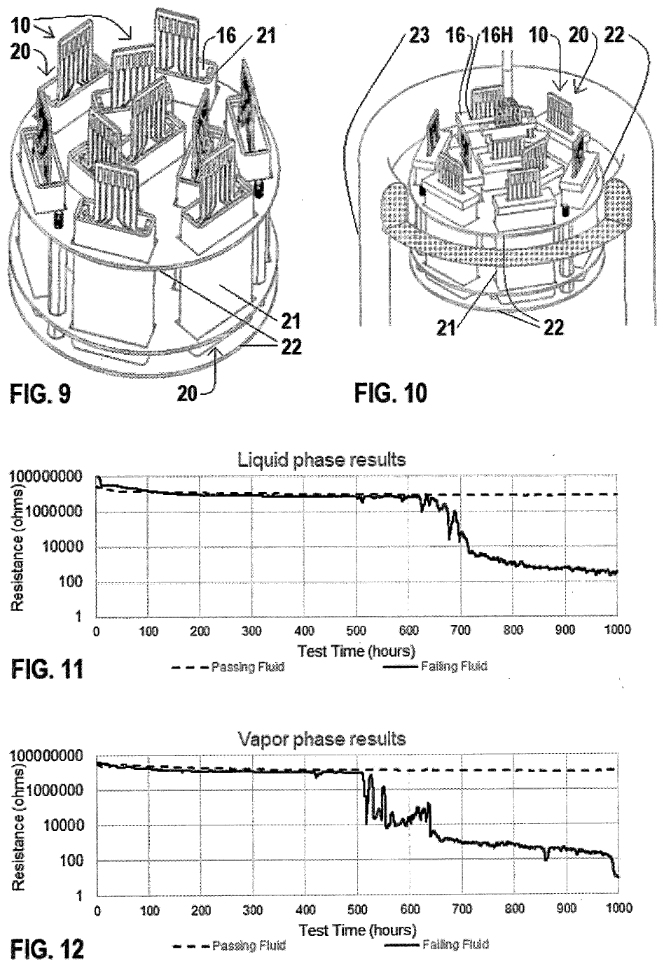

In addition to providing the conductive traces 12 of copper in the two interlacing finger pattern sections (and in the additional, outer encircling pattern, i.e., the continuity loop trace 12T for measuring change in electrical resistance related to depletion of conductive traces 12 notably from corrosion), it is desirable to maximize residence time of the test fluid with minimal mixing thereof, and so an option may be provided for a second surface opposite the trace patterns on an opposing board. This can restrict fluid flow by controlling the gap spacing between opposing boards at a very small distance. Beneficially, the gap spacing is narrow, for instance, at most about three hundred (300) microns (about 0.012 in.), typically within a range, independently at each occurrence, of about from 50-250 microns (about from 0.0020-0.0098 in.), about from 80-160 microns (about from 0.0031-0.0063 in.), about from 100-150 microns (about from 0.0039-0.0059 in.) or about 120-135 microns (about from 0.0047-0.0053 in., for example, at an about a 127-micron (about 0.0050-mm) distance. This second surface can conveniently be provided by using a second circuit board or a blank board (covering board) that is similarly or otherwise appropriately sized. The concept essentially is to trap fluid in this narrow volume, which is termed, “gap.” Two basic configurations with respect to a sole circuit board and opposing board(s) are depicted in FIGS. 4-8 and so forth.

The single-board setup evaluates the deposit tendency in a more open environment. The two-board setup allows for the tight spacing as described above, and the third setup is a combination of the two with respect to one board having an opposing surface with the narrow gap spacing and the outer board being in an open environment. In the three-board assembly, the non-electrically conductive spacer also provides clearance to make the electrical connections on the other two boards. Spacing between opposite boards is accomplished most conveniently by adding standoffs, for example, copper/alloy standoffs, of the desired height to the otherwise blank circuit board spacer board and holding the board assembly together by providing slots of the appropriate width in the test board assembly holder. Alternatively, spacers such as shims, washers and the like can be used along with a variety of fasteners such as screws, pins, rivets, etc. to hold the board assembly together at the desired spacing. Not only the circuit boards but also any conductive substrate mount support member (test board holder) must be able to withstand operating temperatures, for example, up to about 180° C.; and, as with the circuit board stock, conductive substrate mount support members must be chemically inert with respect to the test oils, and preferably be non-conductive. Thus, conductive substrate mount support member materials may be PTFE, PEEK, carbon and/or glass fiber reinforced plastics, and so forth the like. Final setup of the test board details and assembly depends on the test fluid application requirements and the sensitivity desired. For example, the spacing between finger trace conductors can be narrowed to increase test sensitivity or the spacing gap between opposing boards can be adjusted.

The test circuit board subassembly (conductive substrate mount on which is mounted the copper as conductive substrate, test board holder and cover, and so forth) is contained in a stainless-steel test cell housing, the assembled test circuit board subassembly and test cell housing together comprising a test cell. For operation, the test fluid is put into the test cell.

Components for monitoring electrical characteristics and changes are provided, to include resistor(s), meter(s), and so forth and the like. Sensor(s) may be provided to monitor and control the temperature of the test fluid at the target setpoint and/or the temperature of the vapor space.

The test-fluid-containing test cell may be heated. Heat can be provided by source(s) external to the test cell such as a conventional hot oil bath, a solid dry block bath, a dry block bath with other conductive media. Heat may be provided by a source integral with or inside the test cell housing. The heating may be such that a temperature of about 180° C. or even higher is made available during the testing. Temperature control can be provided to be within +/−2° C., preferably within +/−1° C. for the duration of the testing, for example, five hundred hours and in certain cases up to one thousand hours.

A battery of individual test cells can be arrayed in a carousel or other framework. Such an array spaces individual test cells apart from one another so that separation and spacing criteria are met for keeping any heating or cooling uniform between or among test cells. The number of test cells can vary but is advantageously about from six to twelve or higher. Arrangements that allow for convenient test cell removal and replacement, and cleaning to minimize cross contamination between runs are preferred.

Optionally, the test cells can be covered to minimize air exposure and/or vapor loss. Configurations that enable tighter sealing or pressurization with either an inert gas, for example, nitrogen gas, or a reactive component, for example, oxygen gas, may be provided.

Beneficially, data logging and other computerized devices are provided. For example, standard single-ended or differential data loggers can be utilized, or preferably custom designed data acquisition, measurement multiplexing, and data storage solutions are employed.

Although the test cells may be uncovered, covering the test cells can provide more meaningful results. Thus, not only can be provided an upper vapor-blocking portion of support members, through which a slot can be provided for insertion therethrough of a circuit board in close registry to inner surfaces of the slot, but also to significant effect a cover for pertinent test equipment such as by a blanket or shroud to cover over the test cells and heating bath during testing can be employed. Thus, results are made more accurate, precise, hence, more reliable.

In general, preferred apparatus can be arranged in various formats but basically is composed of the following components:
Heating apparatus and a test cell holder that can accommodate multiple test cells.
Data collection hardware (minimum six inputs per cell) with voltage and temperature measurement capability.
Test cells and uniquely designed test circuit boards. These include fixturing and spacers to enable stacked board arrangement, tight spacing requirements, and to hold a circuit board assembly in place.
Connectors and cabling to connect signal wires from test cells to data collection system.
Computing system, for example, either an external laptop or computing device, or a device embedded in the data collection system.

### Method

Beneficially, exemplary apparatus as discussed above and/or below is employed.

The method involves exposing metallic conductors that are closely spaced to fluids at elevated temperatures. The nominal test temperature is 150° C., which is within a desirable test temperature range about from 80° C. to 150° C. or 180° C. A constant DC voltage supply, for example, nominally 5V, is applied continuously throughout the test to the patterned sections.

The test circuit board subassembly contained in the stainless-steel test cell housing is filled with test fluid to the level between the two patterned sections. The test cell is heated, for example, to nominally 150° C., or from about 80° C. to 150° C. or 180° C., with the level of the heating media of a silicone oil or another stabilized heat-transfer fluid of the external heating bath varying between 50% and 100% of the test cell height. The level or contact area may be manipulated to vary the difference between liquid and vapor temperatures, or an oven could be used if even more uniformity between the phases is desired.

As alluded to above, the temperature is controlled to within +/−2° C., preferably to within +/−1° C. for the duration of the test, say, one thousand hours, with the temperature of the test fluid monitored. Temperature of the vapor space is also monitored.

The test cells are covered but not sealed so as to avoid pressure build up from heating. As disclosed above, the nominal 5V DC voltage is applied continuously during the test with the two open loops and the conductive loop measured in regular intervals. Data is captured and plotted against time.

For each test board, a voltage reading from each of the finger patterns is taken across a 1000-ohm resistor using an analog to digital converter in a data logger. One reading is taken every ten minutes, but this interval could vary, say, about from a minute to an hour. This reading is converted into a resistance value using the following formula:

$$Ω = \frac{( 5 - V ) \times 1 , 000}{V} ,$$

and is plotted against time. An internal computer may convert the voltage to resistance and plot it in real time. Smoothing techniques such as moving averages may be employed as an option. A 4-hour moving average of data collected at 10-minute intervals can be employed. Plotting of resistance data on a logarithmic scale can be carried out. Example data from liquid and vapor phases are shown in FIGS. 11 and 12, respectively.

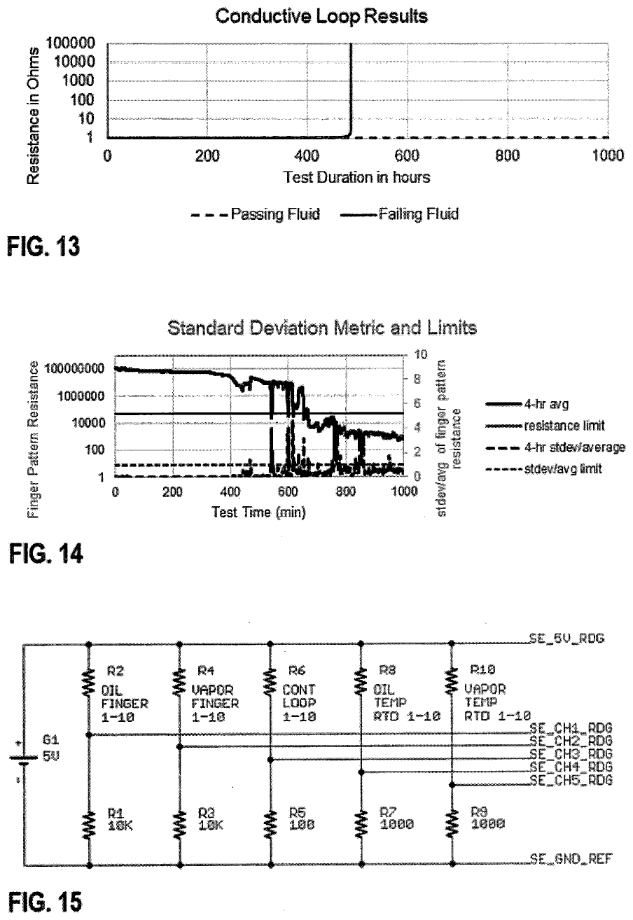

The conductive loop is also monitored in a similar circuit, only in this case the starting resistance is about zero as this is a continuous loop of copper/alloy tracing. A set of exampary test results is shown in FIG. 13. Here again, a 4-hour moving average can be advantageously employed. To improve sensitivity a 4-wire resistance measurement can be employed with the additional two contacts used to measure and compensate for lead wire and connection losses. The data logger employed is an Agilent 34972A data logger. Another data logger may be employed such as another commercial off-the-shelf instrument or a custom designed data logger, so long as in either case it has an adequate number of measurement channels and sufficient voltage and temperature measurement resolution.

For the test, sample cells are arranged in the heating bath with appropriate spacing. In the case of a liquid bath, a framework or carousel is used to suspend test cells in the heating media to ensure uniform temperature distribution from test cell to test cell, for example, about from 1-2 inches (about from 2.54-5.08 cm) apart from one another in a liquid bath at the test temperature, for example, nominally 150° C. The number of test cells tested together is limited by bath size and data collection capacity, but preferably is at least about six to a maximum of about sixteen, say, ten or fourteen. Included in the framework design is the ability to adjust the immersion depth of the test cells in the heating media. The depth of the test cells in the heating media is adjusted based on the liquid/vapor temperature split desired. For example, to minimize the difference between liquid and vapor temperatures, the test cells would be situated so that the heating media level is near the top of the container. Alternatively, the heating media could cover only the liquid portion of the sample, creating a larger temperature differential between the two phases. The test is started when the temperatures of the samples in the test cells reach the desired setpoint, for example, 150° C., and time stamped data collection begins.

The resistance of the three circuits is tracked along with temperature, and monitored for the duration of the test, which, for example, is run up until a maximum of one thousand hours. Conductive deposits are characterized by a sharp drop in resistance from essentially an open circuit to start, to near zero at complete failure. A passing fluid is characterized by minimal resistance loss where the measured resistance remains above 50,000 ohms up to a 500-hour or even a 1000-hour or so test limit. This is tracked separately in both the liquid and vapor phases. Refer to FIGS. 11 and 12 and so forth for examples. The 1000-hour test limit provides a good window to identify possible fluid failure during testing. Shorter or longer times may be employed depending on the fluid tested, say, an about 500-hour or about 600-hour or about 800-hour test limit, or an about 1200-hour, about 1500-hour, or about 2000-hour test limit.

In addition, the conductive loop is monitored for an increase in resistance, which is an indication of material loss from corrosion. This provides insight into the corrosion tendency of the test fluid in relation to the deposit behavior. Thus, it is known in the art that conductive deposits are related to copper corrosion, but the nature of that relationship and interaction with other additives is not yet clear. And so, for example, a sample can have poor corrosion characteristics but not form deposits, and vice versa. Collection of this data provides researchers with additional information from which that relationship may be better understood. FIG. 13 is one example.

Optionally, visual examination of the test boards and chemical analysis of the residual fluid or deposits can be done at the end of the test to identify anomalous behavior and to verify any increase in conductance is from deposits and not an increase in fluid conductivity. This analysis may also be used to determine the composition of deposits and understand relationships between fluid chemistry, amount of deposit, and speed of deposit formation. For example, comparison of properties such as metals composition, degree of oxidation as determined by FTIR, electrical conductivity of fresh vs. end of test fluids can be performed.

### Further Considerations

Configurations that help accelerate the test are important. Since a chemical reaction is involved, varying temperatures may be carried out, run by run, or within runs. For instance, a higher temperature may be employed to effect. If reaction kinetics can be improved without significantly shifting thermodynamic equilibrium, deposition phenomena may be accelerated. The chemical composition of fluids and deposited material may be analyzed to verify chemistry.

Deposition rates may be altered or remain unchanged by adjusting voltage, say, from 5V to 24V. Also, altering the spacing between the traces on the circuit board or between the test and opposing boards may influence deposition. The closer the conductors (e.g., fingers) are, the easier it is to build a so-called conductive deposit bridge, and so the more sensitive the test. Increasing the voltage for acceleration of deposition, however, is not as clear, as heating of the conductor would also have to be considered.

The number and arrangement of the finger traces may be varied for effect. For instance, if there were twice the number of such traces or changes to the board width across which such traces were provided, the greater could be the probability that a deposit would form across these fingers.

As mentioned, other metal(s)/alloy(s) can be substituted for the copper/alloy. Pass/fail criteria may be improved through noting that in-situ comparison of the resistance curves may be compared against a reference fluid with a threshold deviation from reference employed as criteria; a rate of change of resistance may be utilized as the test response; and an increase in variation may be utilized as the test response, say, by utilizing the standard deviation from a moving average. FIG. 14 shows an example resistance plot that shows the ratio of a 4-hour moving standard deviation to a 4-hour moving average as a possible pass/fail metric. This variation-based metric provides an alternative measure for indicating formation of deposits.

In-situ chemical analysis of test fluid for deposition precursors, for example, cupric sulfide, a mixture of copper sulfides, or copper compounds containing sulfur as sulfide, in a sulfate, and so forth, in general may be employed. This could be combined with resistance measurements. For example, sampling time could be triggered by a resistance drop below a specified threshold, detection of an increase in the standard deviation of a specified moving average of the resistance measurement, especially in a liquid phase.

The voltage may be varied over the course of time to simulate field conditions for vehicle components experiencing varying levels of current and voltage. For instance, voltage could be applied only during measurement intervals or with any duty cycle up to the constant application employed as a standard.

Connections at the test board and data logging system may be improved. For example, a board/card edge connection can be used in place of spade terminals or soldered connections of individual wire leads on the test board.

### Deposit Resistance Measurement

The present apparatus and method mainly measure the extent to which lubricants may cause conductive deposits that could short out electric circuits. The chief measurement for this is observed through the resistance created by conductive deposits formed between two isolated sets of conductors, for example, each configured as inter-digital finger patterns.

There are a number of ways to measure a resistance, but a series resistor method is used in exemplary embodiments of this invention. This is so that the test finger pattern constantly has a bias voltage applied during the testing.

The test measurement circuit is built as follows: First, a 5V power supply is used to apply DC voltage to one side of each inter-digital finger pattern (as well as the conductive loop and temperature measurement devices). The opposite, inter-digital finger pattern is connected to the return and passes through a series resistor (R1, typically 1-10 K-ohm) across which a voltage measurement is made using a single-ended data logger. The inter-digital finger pattern is exposed to the lubrication being tested. This circuit is shown in FIG. 15.

Referring to the oil finger resistance in FIG. 15, the load resistance can be calculated by knowing the supply voltage, the voltage across R1, and the current through the load resistance which is the same as through R1. Thus, for example:

$$Load Current = Measured V ( R 1 ) / R 1$$

$$Load Voltage = 5 V - Measured V ( R 1 )$$

$$Load Resistance = ( 5 V - V ( R 1 ) / ( V ( R 1 ) / R 1.$$

This circuit is repeated for each instance of the inter-digital finger patterns being tested as well as the conductive loop and RTD devices. There are two inter-digital finger patterns per test board, upper and lower, and either one or two test boards per sample. The resistance of R1 can be selected based on the range of measurement expected for a given circuit. Thus, for example, a 10-K-ohm resistance is suitable for finger resistances; a 1-K-ohm resistance is matched well with temperature measurement resistors; and a 100-ohm resistance, a much lower resistance, could be used for the conductive loop.

A triple board embodiment has a test board, spacer, and an outer test board. The outer board may be used to perform this measurement without the close gap.

### Additional Disclosure

In the apparatus, a continuity loop 12T (a conductive loop trace that may encircle interlacing fingers 12 on the board 11) may employ 2-wire measurement in place of 4-wire. Wiring is simplified thus although it is at the expense of some sensitivity. The 4-wire configuration accounts for resistance in wire leads/connections, and can be employed for discerning very small changes in resistance, as is the case potentially in the conductive loop where reduction in cross-sectional area due to corrosion is investigated. Even so, the 2-wire configuration can be adequately and efficiently applied to the task at hand.

Temperature measurement is important for the methodology, particularly in the vapor section since that can vary with test cell immersion depth or heater configuration, sample properties, and potentially with ambient conditions. Standard junction-type thermocouples can be utilized but require sufficient data logging resolution and can be cumbersome to mount repeatably within the test cells. RTD probes such as well known PT100 probes can be employed or RTD devices can be surface mounted to the test board. The surface mounted variant not only fixes the measurement location in a repeatable manner but enables wire lead connections to be integrated with other test board signals. Advantageously, these devices are mounted on the back side of test board 11 and connected by a common card edge connection.

Wire management is a key consideration. As alluded to above, with each test cell requiring up to twelve signal wires and a test unit holding up to sixteen cells, managing this number of connections and wiring presents a significant challenge. This is most effectively managed, first, by employing a board/card edge connection at the test board where contacts on the test board are mated with similar contacts on a connector. This replaces soldering or other individual connection means at the test board terminals with a simple press on connector.

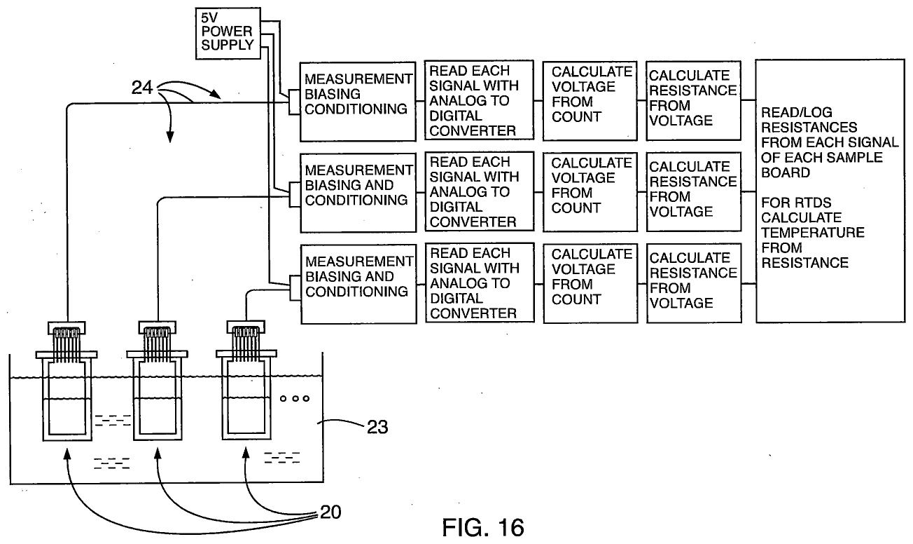

Among options that may be employed for data collection is a centralized data logger. In the centralized logger, in general, wires serving a test cell may be bundled into a cable to lead to an interface or buss board to data logger. Optionally, a distributed approach where data is processed and stored or communicated at each test cell location advantageously can be considered and, when desired, employed. See FIG. 16 for a block diagram showing data processing functions required to perform the necessary conversions and calculations to yield output in terms of resistance, in ohms.

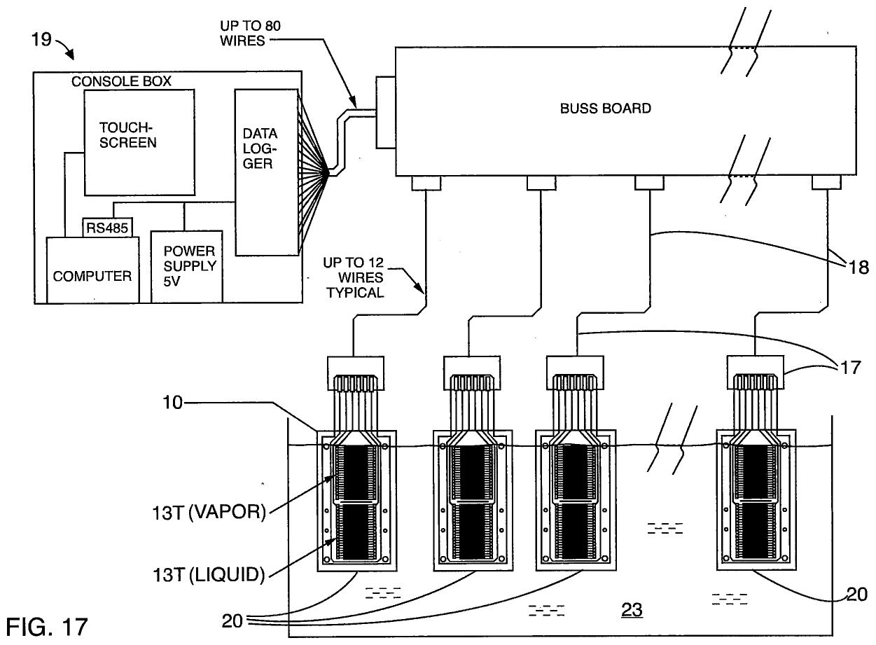

In a centralized approach, for example, the finger test boards are wired to cables, say, twelve wires per test cell, and soldered or connected via an edge connector. The cables connect to a signal interface board, which interfaces the test board signals to a data logger, say, a commercially obtained data logger such as the Agilent 34972A data logger, with up to six individual wire connections per test cell. If employed, TC probes may wire directly to the data logger. The data logger can communicate with a laptop computer or similar for calculations, data storage, and display. The interface board may be housed inside a console box. The apparatus can be user-friendly. See, FIG. 17.

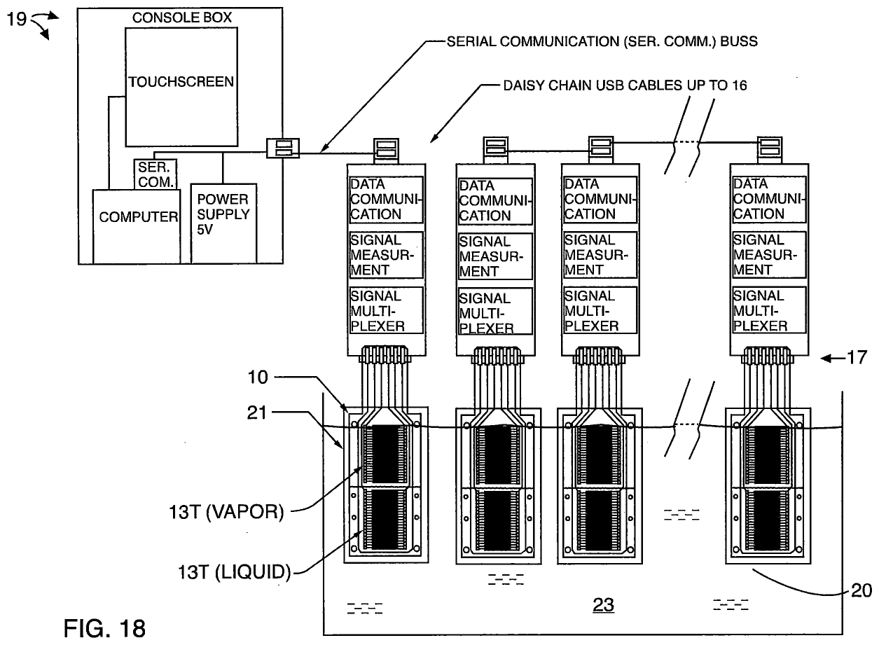

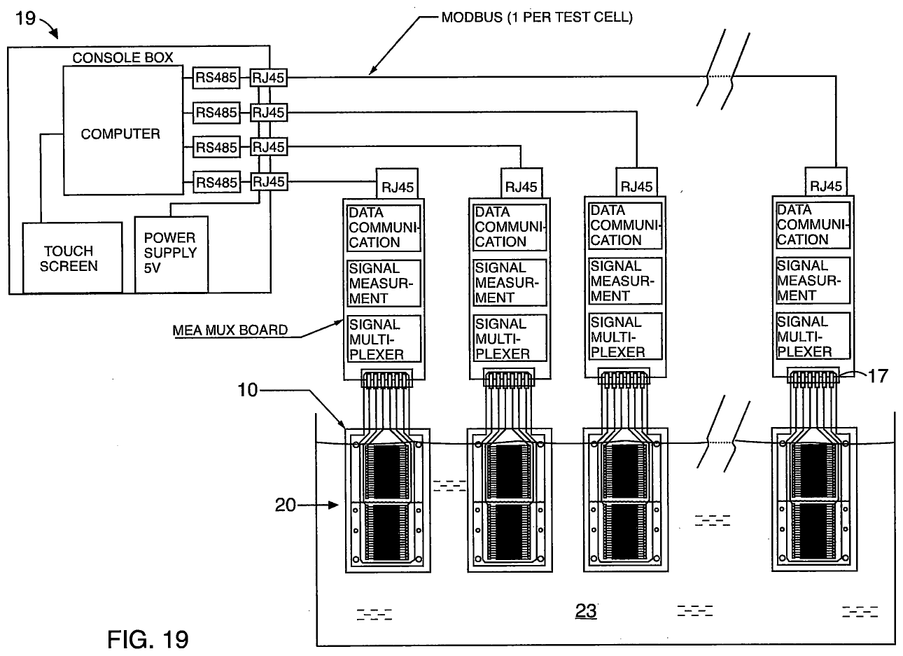

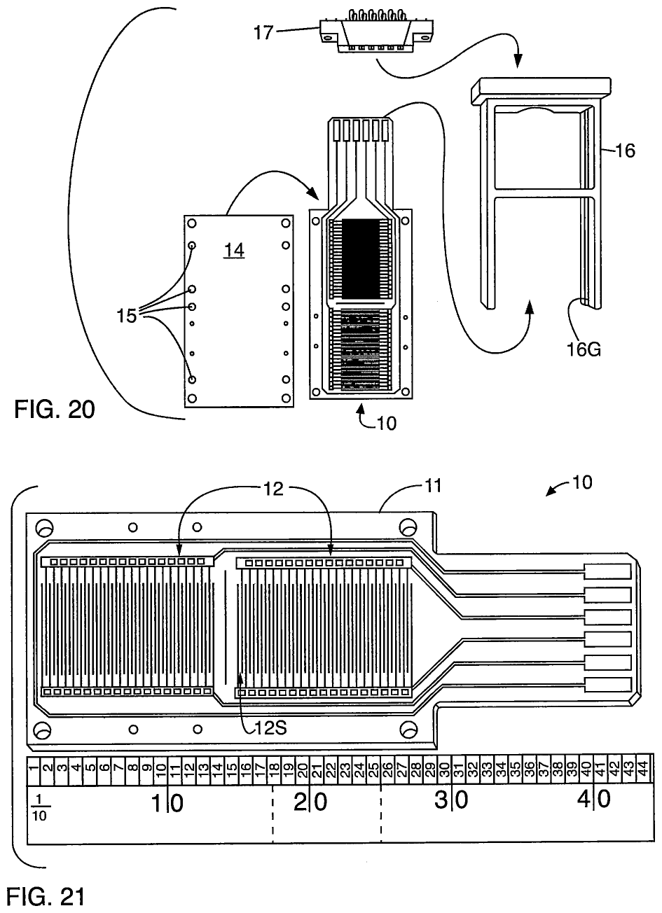

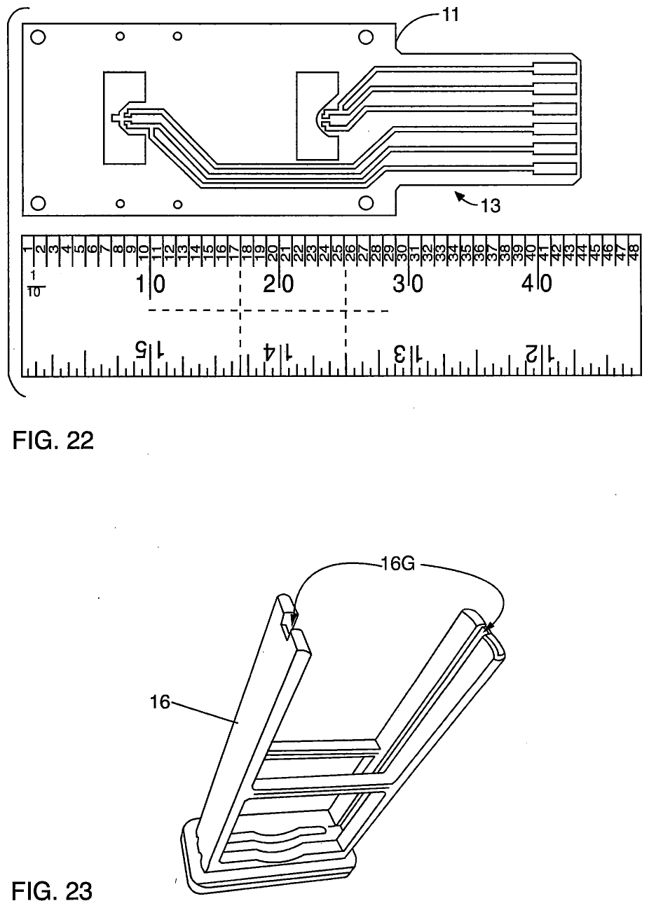

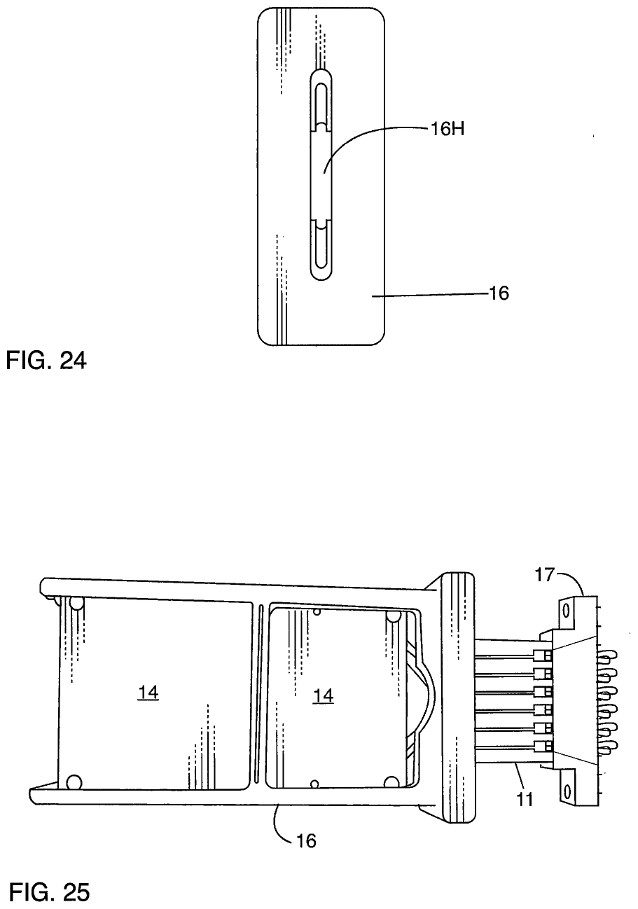

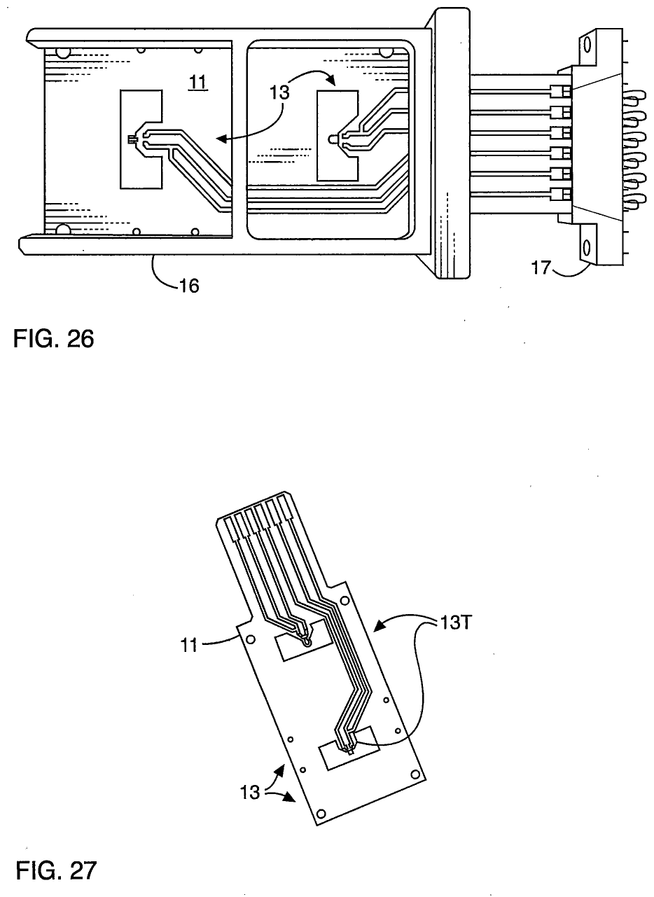

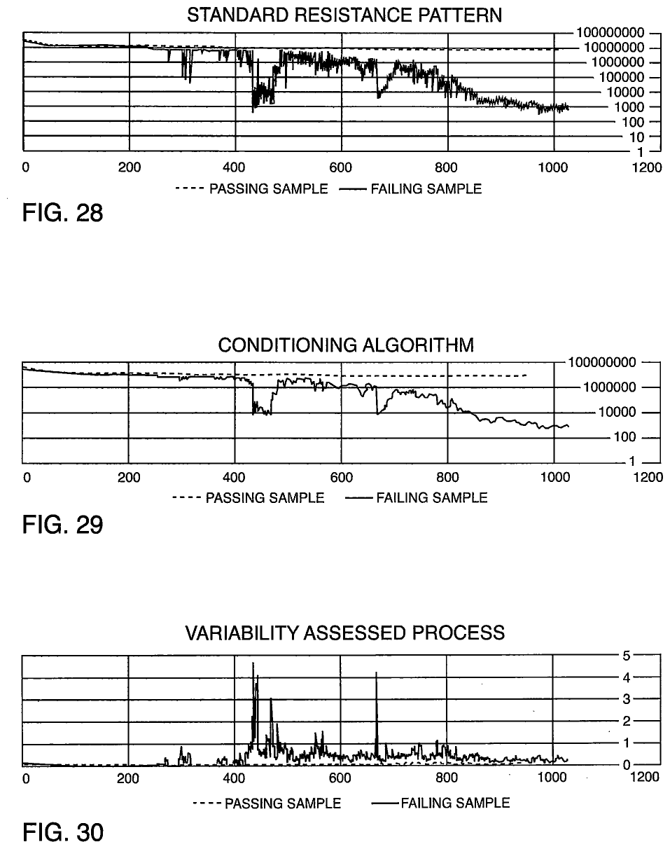

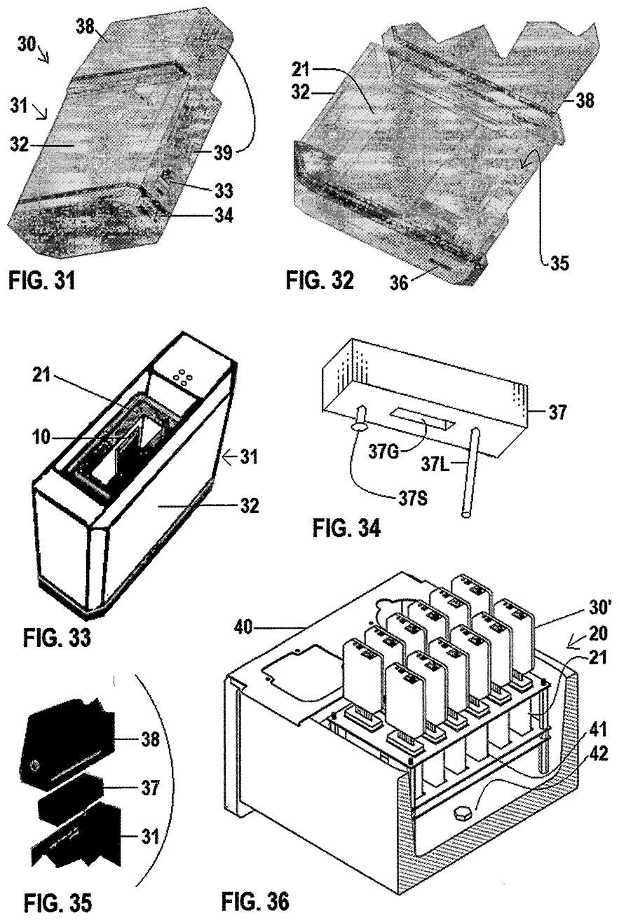

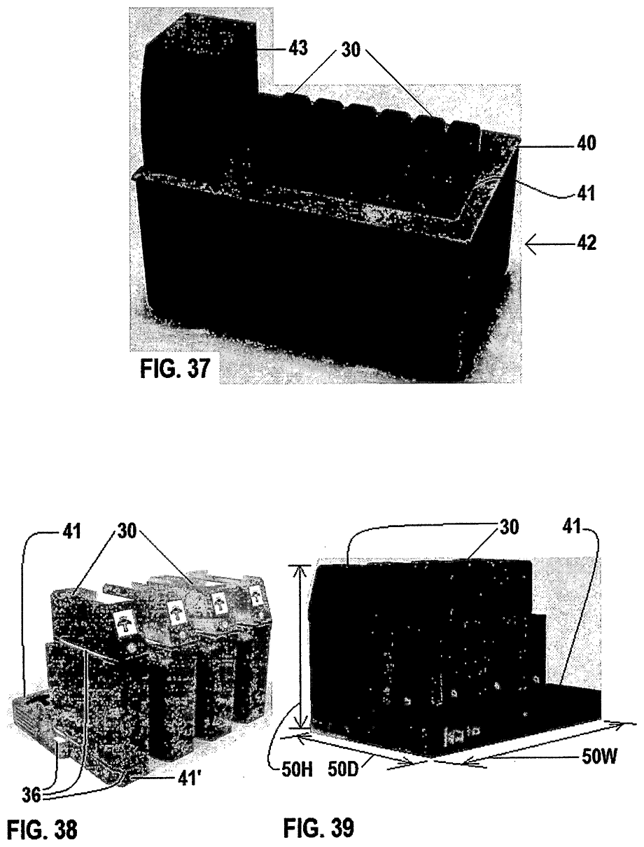

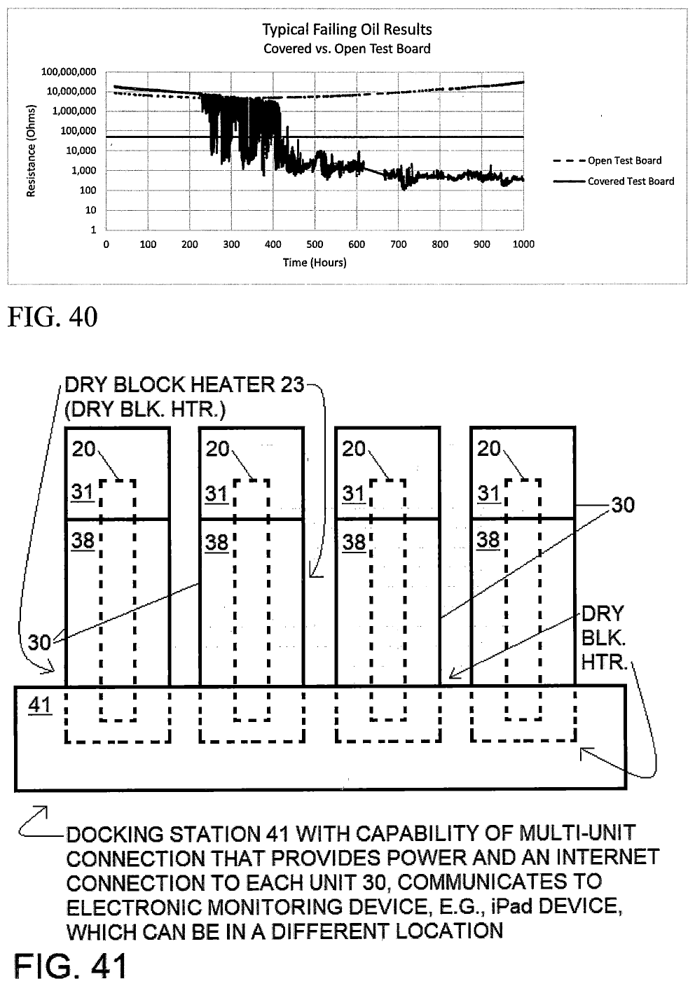

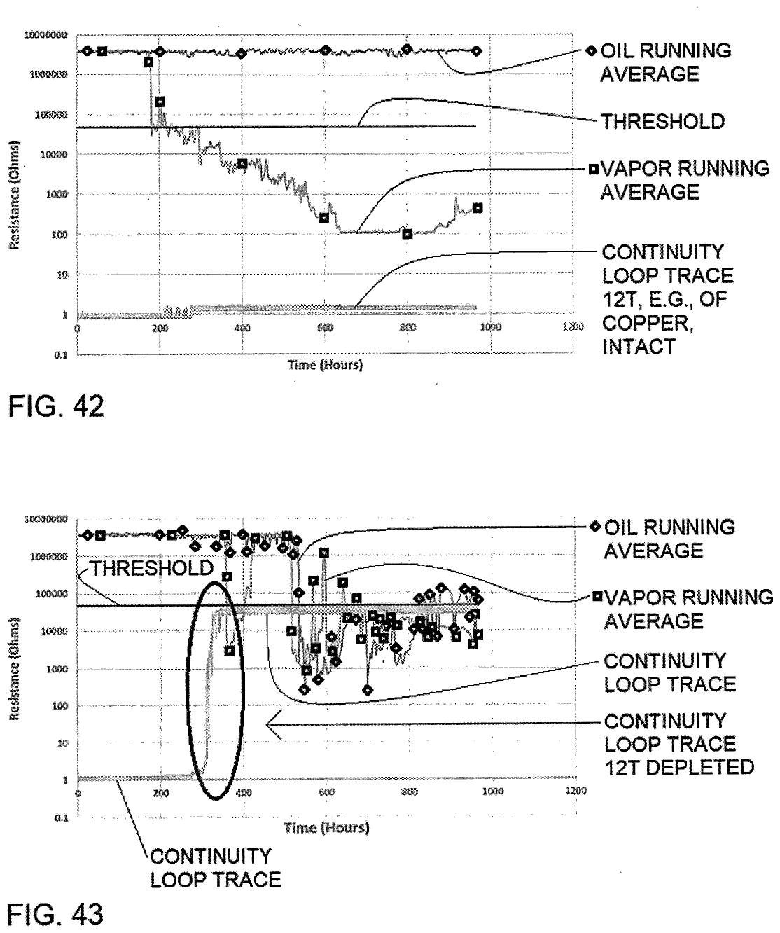

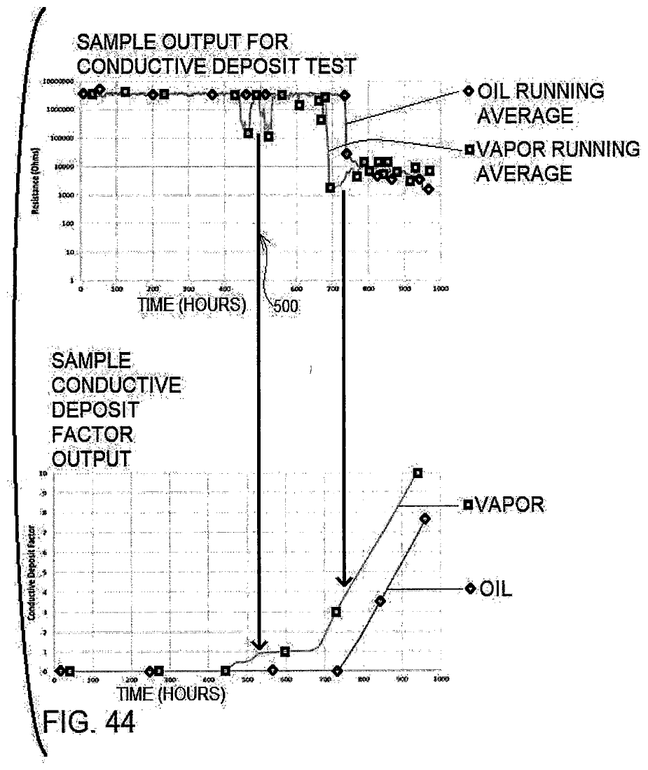

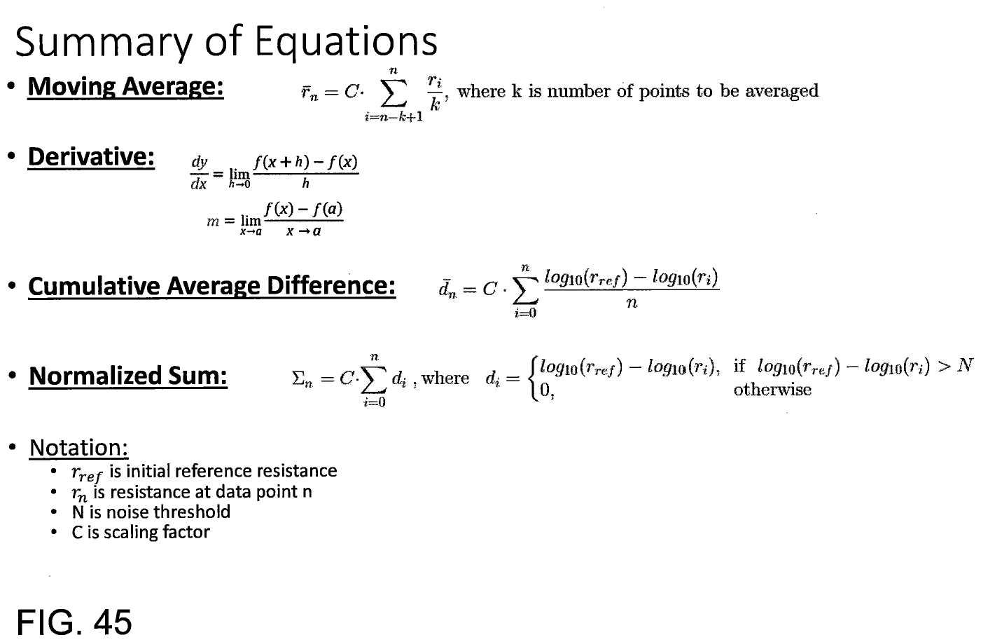

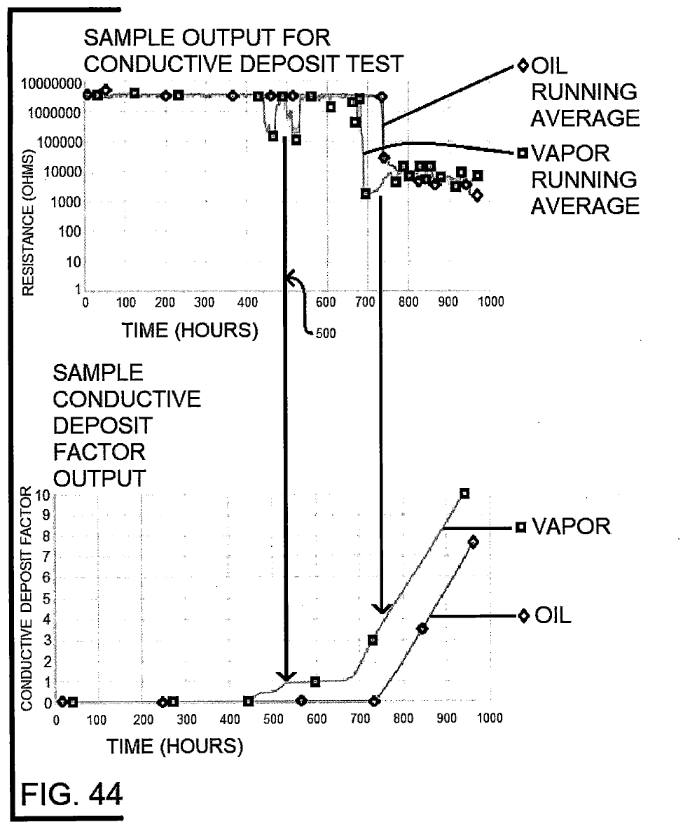

In a distributed approach, for example, each test board mates to a corresponding MUX device via a cable or edge connector. Temperature sensors can be positioned on the obverse side of a test board, opposite the copper fingers, etc. The MUX device collects voltage data, performs necessary conversions, and transmits resistance data to the data collection system on demand. Provision for test cell addressing can be accomplished by software, switches on the MUX device, or via direct connection through individual cables. Six measurements via a 16-bit ADC and 5V 1000-ohm series resistance circuit may be conducted. In one embodiment, shown in FIG. 18, the MUX devices are daisy-chained together in series fashion over a serial communications buss. For example, data from individual test cells are communicated via an RS485 device over a USB buss so that only one cable passes from the console box to the test instrument. Periodically, say, at ten-minute intervals, the console box reads data from a given MUX device and logs data over time to calculate temperature readings and electrical resistance readings, which can be displayed on a laptop or touch screen. As with the centralized approach, typically fresh test boards and fresh card edge connectors are employed per each test. In contrast to the centralized approach, there is one multiplexing measurement (MEA) device for each test cell. Series electrical connection to deliver the supply voltage and transmit data is provided, as found in the centralized approach. Also, as an alternative, each test cell could be cabled separately, as in the centralized approach. See, FIG. 19. In this case, the central data processing device communicates with each test cell individually via these dedicated connections, eliminating the need for more complex addressing features, albeit at the expense of additional cabling.

### Further Embodiments

In further embodiments, wireless communication can be provided in lieu of or in addition to wired communication such as with data cables. For example, this can be provided by substituting the RJ45 connector shown in FIG. 19 with a wireless transmitter as known in the art. This eliminates cables and connections between the MUX devices and central console.

Further improvements can concern dry block heater concept details such as substituting the liquid bath described in previous embodiments with a dry heating block having receptacles sized to fit the test cells, sand bath, and so forth and the like. Such has (have) advantage(s) of avoiding inconvenience and hazards of working with liquid heating media, and better enables an ability to remove/replace individual samples while the overall system remains in operation. Similarly, a heater block can be sized to accommodate a single test cell with heater insulation, and independent temperature measurement and control capability all integral to a single cell heater unit. A film type heater may be employed in such an application.

Moreover, the MUX device concept can be taken a step further, basically making each test cell a stand-alone unit that can be operated independently with data collection, processing, and storage all integral to the MUX device. Whereas foregoing descriptions above include the MUX device monitoring and transmitting the data to central processing device or computer on a predetermined interval, the stand-alone concept has all this done on that data collection head. The resulting data files can then be uploaded to an external device through a USB drive, ethernet connection to a computer, wireless file transfer, or even through a QR code that can be scanned using a smartphone, and so forth and the like.

In combining the latter two concepts, there basically is provided an independent test cell unit with a fully independent MUX device, which is capable of heating a sample as may be necessary or otherwise controlling its temperature, collecting voltage data, performing resistance calculations, and storing data for reporting or additional processing. Power for heating (and controlling temperature and perhaps cooling) and applying voltage to the measurement circuit and MUX device can be provided conventionally via a DC voltage supply connection, which may be hard-wired or be a connector such as a pogo pin (a spring-loaded electrical connector mechanism) and so forth and the like. Communication between the MUX device and heater/temperature-control/cooling section can also be facilitated by ethernet, wireless, or pogo pin connections and so forth and the like. Pogo pin connections eliminate additional cabling, making for an efficient, uncluttered device, which is compact and conducive to mounting onto a power strip or hub.

One or a plurality of the individual stand-alone devices may be employed, alone or as an aggregate. Such individual stand-alone devices generally include a combined test cell heater with a top section containing the MUX device for data collection and processing and a bottom section a test cell container with a test cell temperature regulator, which may include or be, for example, the dry block heater such as mentioned above. The test cell to include as depicted in the drawings can be connected with or to a base where heater power is delivered through a connection port, pogo pins, and so forth and the like. One, two, three, or four or more of such stand-alone concept constructions can be employed in such a fashion in the practice of the invention. This embodiment can include the separate RTDs for temperature measurement.

Also, test cells may be provided with test boards having different conductive substrate dimensions or patterns from other test boards employed in testing and run against different aliquots of the same test fluid samples. Then too, test cells may be provided with test boards having different conductive substrate material from other test boards employed in testing and run against different aliquots of the same test fluid samples.

Other embodiment(s) may be provided as or in conjunction with the invention.

One or all of these further embodiments can be employed alone or in combination in the foregoing method of use.

### Some Identifications/Recapitulations

In general, the following may apply hereto:

A “conductive deposit receiver” refers to or can be reckoned as a test circuit board 11. The test circuit board can have the interlacing comb or finger patterns (traces) 12, for example, spaced apart 12S by a nominal 0.3-mm distance with a 0.4-mm width to the trace 12. The term, “spacing,” can be used for the distance between traces. (On the other hand, as noted in the next section, a “gap” would represent the distance between two boards). Also, the test circuit board beneficially has a conductive loop trace 12T, and, generally on its back side, one or more RTD devices, say, two RTD devices, one to measure the temperature of a sample in its liquid phase and a second to measure the temperature of the sample in its vapor phase. Signals terminate at an edge connector.

A “spacer board,” or the like, can create a narrow gap intended to restrict fluid movement in proximity to the traces on the test circuit board. Advantageously, the spacer board is inert electronically. This may be referred to or reckoned as a “cover board,” which, however, should not be confused with the test cell cover. Standoffs built into the board, for example, copper posts added in circuit board manufacture, can be included. Although washers, shims, and so forth may be employed as standoffs, they can be difficult to handle. A board holder 16 can be 3D printed, but doing so may not have the necessary tolerance in the slot width to hold two boards such as a test board 11 and a cover board 14 at the desired gap spacing. Accordingly, such boards may be clamped or otherwise held more reliably close together with fastener(s) such as screw(s), rivet(s), stud(s), and so forth and the like, and/or adhesive(s) and so forth and the like.

A “deposit receiver assembly,” or the like, refers to a combination or assembly of the board holder 16, conductive deposit test fluid deposit receiver board 11 and spacer board 14. A board holder 16 can be made as one piece and include the cover board 14, but as noted above may be adapted to include means to clamp or otherwise hold boards together.

A “sample container,” or the like, refers to a test cell housing 21, i.e., the vessel into which the sample and the deposit receiver assembly can be introduced. The sample container may be formed in a boxlike shape and be made of suitable glass, ceramic, or metal(s), say, stainless steel.

A “test cell” refers to a sample container with a deposit receiver assembly inserted and ready for testing, being tested, or after having been tested.

Some further features of the invention are listed as follows:

| Feature | Comment |
|---|---|
| 30 | Stand-alone unit, generally with MUX device in upper |
| | portion 38 thereof |
| 30′ | Unit with MUX device in an upper part, but not a stand-alone |
| | unit |
| 31 | Lower portion of stand-alone unit 30 |
| 32 | Lower housing |
| 33 | Ethernet connection |
| 34 | Heater power connection |
| 35 | Circuit board providing temperature control function |
| 36 | Lights to indicate operation |
| 37 | Adapter between lower portion 31 and upper portion 38 of |
| | stand-alone unit 30 |
| 37G | Groove to receive and electrically connect conductive substrate |
| | deposit unit 10 |
| 37L | RTD probe in adapter 37 for liquid phase temperature |
| | measurement |
| 37 S | RTD probe in adapter 37 for vapor phase temperature |
| | measurement |
| 38 | Upper portion of stand-alone unit 30 |
| 39 | Ventilation slots |
| 40 | Liquid bath cover |
| 41 | Bay or dock |
| 41′ | Base |
| 42 | Liquid heating bath |
| 43 | Temperature control unit |
| 50D | Distance across, for example, about a 246-mm distance |
| 50H | Height, for example, about a 213-mm distance |
| 50W | Width, for example, about a 328-mm distance |

### Some Configurations And Observations

The overall setup basically comprises, consists essentially of, or consists of, the test cell, heating, and data collection/processing components. These can be arranged as follows:

LIQUID BATH heating, and temperature regulation, arrangement: Multiple test cells, typically 10-12 or thereabout, can be run together, supported at a configurable heating media level by a rack or carousel. Samples are generally run together at a common temperature profile for all samples, typically at a fixed set point, say, at or about 150° C.
Data collection devices connect to the deposit receiver via the card edge connection. Soldered connections onto a multi-wire cable may be employed.
For configurations that use a commercial data logging device such as, for example, Agilent, a cable is used to connect the card edge(s) to a signal interface board (SIB), which provides the applied voltage and contains the resistance measurement circuitry. A second cable connects the SIB to the input channels on the data logger. Voltages are logged at specified intervals, with 10-minute intervals typical in a preferred embodiment, and ultimately downloaded to a computer, for example, a computer loaded with Excel software, for resistance calculations and additional analysis. When a plurality of test cells communicate together on one centralized cable, a centralized configuration is designated.
Distributed design configurations, on the other hand, employ individual MUX devices on each test cell. Each MUX device, however, still connects back to a central computer or processor, which handles test cell addressing, sampling logic, and data storage. Several beneficial configurations for this connection are noted:
   In a first type of such distributed design configurations, test cells are connected, or daisy chained together, i.e., connected in series, by USB cables on a serial communications buss and connected to the main processor via a single connection. The MUX device on each test cell collects voltage data continuously but is sampled by the main processor at specified interval(s), say, at 10-minute intervals. Addressing, i.e., the identification of communicated data as to which test cell that data pertains, is required to maintain sample identity.
   In a second type of such distributed design configurations, test cells are individually connected, say, via Cat-5, Cat-5E, or CAT-6 cables, and data typically communicated, for example, over Modbus communication protocol. With individual cables, the need for addressing is eliminated since each input is hardwired into the main processor. As in the first type of such distributed design configurations, the MUX collects data and is sampled at specified intervals.
   In a third type of such distributed design configurations, the data collection component is taken a step further in that the MUX device not only measures data but adds the ability to store data locally, eliminating the requirement of a central console or processor. This type also has several options for accessing data including wireless file transfer, downloading over USB and so forth and the like. In liquid bath case, it is believed that power for the applied voltage may be applied through a cable or through a docking station.

DRY BLOCK heating, and temperature regulation, arrangement: A centralized heating block that can accept multiple test cells is another potential means to provide sample heating. The rest of the options described in the aforementioned liquid bath arrangement apply here as this just replaces the liquid bath with all else, in general, the same.

STAND-ALONE arrangement: This arrangement integrates all critical functions such as heating, measurement and processing, and data storage in a single unit that contains one test cell. A plurality of such units can be ganged together to appear as a coordinated multi-cell system, which, however, act independently. Provided therein may be such features as the following:
A dry block cell with heater block, heating device, insulation and temperature Regulation capability all in one unit. The test cell is inserted into the dry block.
For measurement and data processing, the MUX device, temperature measurement probes, for example, the PT100 probes, and connectors to the dry block section for the test board and power supply are housed in a data collection head. The upper portion (collection head) mates onto the heater section via mating pins, magnetic connectors or other fasteners that may be easy to use. Data collected and processed on the collection head can be transferred during or after a run, for example, a 1000-hour or so run. This can be done by USB, or wireless transfer as desired.
Nonetheless, as otherwise described above, this collection head configuration design may also be paired with a test cells in a liquid bath setup if so desired.

In addition, it is observed that, in general, in the vapor region of the test cell 20, some liquid is present on a corresponding vapor region of the conductive substrate deposit unit (test board) 10. It is typically present as a film, generally from liquid that wicks up the test board 10. Thus, there can be some interplay or interaction with the liquid and vapor phases in a test fluid sample such that there generally can be two or three categories of fluid interaction with the patterned conductive substrate 12 on the conductive substrate mount (board or card) 11 portions of the test board 10:
In the portion of the test board 10 immersed in liquid in the test cell 20, there generally is interaction with the test fluid sample in a liquid phase.
In the portion of the test board 10 above the liquid in the test cell 20, there generally is interaction with the test fluid sample in at least one of a vapor phase and a liquid phase, the latter, again, typically present as a film.

In general, conductive deposit testing analysis works in the following manner: Patterned tracings 12, for example, interlacing fingers, on a circuit board 11 are supplied with electrical current at a voltage, and the resistance in Ohms is tracked over time. When conductive deposits or dendrites are forming the resistance value changes drastically. See, e.g., FIGS. 11, 12, 14, 28-30, 40, 42-45. At that point, conductive deposits or dendrites have formed, and the test may be terminated or continued until catastrophic failure.

An additional analysis tool in the present testing involves the continuity loop trace 12T. It can be placed in any suitable location, say, near the periphery of the circuit board 11, spaced apart from other tracings to avoid possible conductive deposit/dendrite formation, to monitor loss of electrical conductor employed in the patterned tracings 12, when electricity is passed through. See, e.g., FIGS. 13, 42, 43 and 45. Trends may be evaluated. If continuity loop is depleted anywhere, resistance goes to maximum, such as seen in FIGS. 13 and 43. At that point, the test is stopped, and a different test may be run such as a wire corrosion test.

Test run data can be plotted based on resistance values themselves or modification of such values, for example, as logarithmic values of the resistance values. See, FIGS. 11-14, 28-30, 40 and 42-44. Directly entered or plotted data may be modified by logarithm to determine a sample Conductive Deposit Factor value for data reports. See, e.g., FIG. 44.

### Epilogue

Accordingly, in general, the invention can include its provision as, within, or under any or all such embodiment(s) as follows, or as otherwise found herein:

A conductive deposit test apparatus for testing a test fluid in the presence of an electrical conductor through which an electric current can pass, which comprises a conductive substrate deposit unit having a conductive substrate mount, and mounted on said mount a patterned conductive substrate narrowly spaced apart in a pattern of a plurality of adjacent members forming a conductive deposit test fluid deposit receiver, and a continuity loop trace; a test cell, which includes a test cell housing together with said conductive substrate(s) mounted on said mount, said test cell configured to hold the test fluid during testing; a source of electric power capable of passing through said conductive substrate(s).

In such test apparatus, a non-electrically conductive substrate, i.e., covering element, held in registry with, for example, parallel to, at a narrow separation gap apart from the deposit receiver; provision of a source for heating and/or cooling the test fluid held in the test cell housing during testing; data monitoring and/or analyzing component(s) and/or equipment; test apparatus arranged with one test cell or a plurality of test cells in a central heating bath and/or as individual stand-alone test cell unit(s) with heating and/or cooling, temperature regulation, and data collection integral to individual stand-alone test cell units.

In such test apparatus, provision of wired and/or wireless connection(s).

In such test apparatus, provision of local storage of collected data and an ability to retrieve such data an communicate the data to at least one external device such as, for example, a computer, a smartphone, and so forth and the like.

A method for testing a fluid sample, which comprises steps of providing the aforesaid conductive deposit test apparatus; providing power and optionally heat or cooling to said test apparatus; operating said test apparatus; and monitoring/analyzing data generated therefrom.

Such a method for testing a fluid, wherein the fluid sample is a liquid that can vaporize at least in part, and the generation of conductive deposits is identified by a reduction of resistance across narrowly spaced conductors immersed in the liquid sample and/or exposed to vapors thereof.

Such a method for testing a fluid, wherein corrosion of a conductor, preferably a metal and more preferably including or of copper, is directly sensed by measuring an increase in resistance across the conductor.

### CONCLUSION

The present invention is thus provided. Various feature(s), part(s), step(s), subcombination(s) and/or combination(s) can be employed with or without reference to, or order of, other feature(s), part(s), step(s), subcombination(s) and/or combination(s) in the practice of the invention, and numerous adaptations and modifications can be effected within its spirit, the literal claim scope of which is particularly pointed out by the following claims:

What is claimed is:

1. A conductive deposit test apparatus for testing a fluid sample in the presence of an electrical conductor through which an electric current can pass, which comprises a conductive substrate deposit unit having a conductive substrate mount, and mounted or formed on said mount, as said electrical conductor, a patterned conductive substrate narrowly spaced apart in a pattern of a plurality of adjacent members, which form a conductive deposit test fluid deposit receiver; a test cell, which includes a test cell housing and the conductive test fluid deposit receiver when said receiver is contained therein, said test cell configured to hold the fluid sample during testing; a source of electric power capable of powering at least one heater for heating the fluid sample during testing, of passing through the patterned conductive substrate, and of powering at least one component for measuring and reporting data related to the fluid sample; wherein the apparatus is adapted to measure and report electrical resistance of the patterned conductive substrate during the testing as a measure of deposit formation from the fluid sample on and/or between said adjacent members of the patterned conductive substrate during the testing, and wherein the apparatus includes the following features (A, B, C):
(A) the apparatus is configured with a non-electrically conductive covering element to constrain movement of the fluid sample in a narrow gap in proximity to the conductive substrate(s), wherein the movement of the fluid sample in proximity to the conductive substrate(s) is constrained by the non-electrically conductive covering element held in registry with the conductive substrate mount to form the narrow gap;
(B) the fluid sample includes a liquid phase having an upper surface; and the patterned conductive substrate is configured in separate arrays forming separate patterned conductive substrate mount circuits on the same conductive substrate mount, a first array for immersion in and interaction with the fluid sample below the upper surface of the liquid phase, and a second array for positioning and interaction with the fluid sample above the upper surface of the liquid phase of the fluid sample; and
(C) a continuity loop trace mounted or formed on the conductive substrate mount to monitor loss of the patterned conductive substrate of said first array and said second array, powered by said source of electric power, and measurable and reportable by the apparatus during the testing.

2. The apparatus of claim 1, wherein both the conductive substrate mount and the non-electrically conductive covering element are substantially planar such that they are held substantially parallel to one another at a fixed separation distance for the narrow gap.

3. The apparatus of claim 1, wherein the narrow gap is at most about 300 microns.

4. The apparatus of claim 2, wherein the narrow gap is about from 50 to 250 microns.

5. The apparatus of claim 3, wherein the at least one conductive substrate is or includes copper; and the narrow gap is about from 100 to 150 microns.

6. The apparatus of claim 4, wherein the patterned conductive substrate is or includes copper; and the narrow gap is about from 120 to 135 microns.

7. The apparatus of claim 1, wherein the patterned conductive substrate in said first and second arrays is mounted or formed in a pattern of interlacing comb teeth or fingers.

8. The apparatus of claim 2, wherein the patterned conductive substrate in said first and second arrays is mounted or formed in a pattern of interlacing comb teeth or fingers.

9. The apparatus of claim 4, wherein the patterned conductive substrate in said first and second arrays is mounted or formed in a pattern of interlacing comb teeth or fingers.

10. The apparatus of claim 6, wherein the patterned conductive substrate in said first and second arrays is mounted or formed in a pattern of interlacing comb teeth or fingers.

11. The apparatus of claim 1, wherein a docking station with capability of multi-unit connection that provides power and an internet connection to each unit is provided, with individual test cell(s) as stand alone unit(s) having data collection integral to data monitoring and/or analyzing component(s) is (are) also provided, and dry block heating is employed.

12. The apparatus of claim 2, wherein a docking station with capability of multi-unit connection that provides power and an internet connection to each unit is provided, with individual test cell(s) as stand alone unit(s) having data collection integral to data monitoring and/or analyzing component(s) is (are) also provided, and dry block heating is employed.

13. The apparatus of claim 6, wherein a docking station with capability of multi-unit connection that provides power and an internet connection to each unit is provided, with individual test cell(s) as stand alone unit(s) having data collection integral to data monitoring and/or analyzing component(s) is (are) also provided, and dry block heating is employed.

14. The apparatus of claim 10, wherein a docking station with capability of multi-unit connection that provides power and an internet connection to each unit is provided, with individual test cell(s) as stand alone unit(s) having data collection integral to data monitoring and/or analyzing component(s) is (are) also provided, and dry block heating is employed.

15. A method for testing a fluid sample, which comprises the following steps, which are not necessarily conducted in series:
providing a conductive deposit test apparatus for testing a fluid sample in the presence of an electrical conductor through which an electric current can pass, which comprises a conductive substrate deposit unit having a conductive substrate mount, and mounted or formed on said mount, as said electrical conductor, a patterned conductive substrate narrowly spaced apart in a pattern of a plurality of adjacent members, which form a conductive deposit test fluid deposit receiver; a test cell, which includes a test cell housing and the conductive test fluid deposit receiver when said receiver is contained therein, said test cell configured to hold the fluid sample during testing; a source of electric power capable of powering at least one heater for heating the fluid sample during testing, of passing through the patterned conductive substrate, and of powering at least one component for measuring and reporting data related to the fluid sample; wherein the apparatus is adapted to measure and report electrical resistance of the patterned conductive substrate during the testing as a measure of deposit formation from the fluid sample on and/or between said adjacent members of said at least one conductive substrate during the testing, and wherein the apparatus includes the following features (A, B, C):
(A) the apparatus is configured with a non-electrically conductive covering element to constrain movement of the fluid sample in a narrow gap in proximity to the conductive substrate(s), wherein the movement of the fluid sample in proximity to the conductive substrate(s) is constrained by the non-electrically conductive covering element held in registry with the conductive substrate mount to form the narrow gap;
(B) the fluid sample includes a liquid phase having an upper surface; and the patterned conductive substrate is configured in separate arrays forming separate patterned conductive substrate mount circuits on the same conductive substrate mount, a first array for immersion in and interaction with the fluid sample below the upper surface of the liquid phase, and a second array for positioning and interaction with the fluid sample above the upper surface of the liquid phase of the fluid sample; and
(C) a continuity loop trace mounted or formed on the conductive substrate mount to monitor loss of the patterned conductive substrate of said first second arrays, powered by said source of electric power, and measurable and reportable by the apparatus during the testing;
providing the fluid sample to said apparatus;
providing electric power to, and operating said test apparatus; and
monitoring/analyzing data generated therefrom.

16. The method of claim 15, wherein both the conductive substrate mount and the non-electrically conductive covering element are substantially planar such that they are held substantially parallel to one another at a fixed separation distance for the narrow gap.

17. The method of claim 16, wherein the narrow gap is at most about 300 microns.

18. The method of claim 16, wherein at least one of the following (A′-C′) is present:
(A′) the patterned conductive substrate and the continuity loop trace are or include copper, and the narrow gap is about from 50 to 250 microns; (B′) the patterned conductive substrate is mounted or formed in a pattern of interlacing comb teeth or fingers; and (C′) in the vapor region of the test cell a film of liquid from the fluid sample is present on a corresponding vapor region of the conductive substrate deposit unit.

19. The method of claim 18, wherein element C′ is present.

20. The method of claim 16, wherein the apparatus includes a docking station with capability of multi-unit connection that provides power and an internet connection to each unit is provided, with individual test cell(s) as stand alone unit(s) having data collection integral to data monitoring and/or analyzing component(s) is (are) also provided, and dry block heating is employed.
